(19) United States
(12) Patent Application Publication
(10) Pub. No.: US 2026/0074959 A1
(43) Pub. Date: Mar. 12, 2026

(54) APPARATUS AND METHOD FOR PERFORMANCE PREDICTION OF MODELS IN AI/ML ENABLED COMMUNICATION NETWORKS

(71) Applicant: Fraunhofer-Gesellschaft zur Förderung der angewandten Forschung e.V., München (DE)

(72) Inventors: Georgios KONTES, Erlangen (DE); Mohammad ALAWIEH, Erlangen (DE); Birendra GHIMIRE, Erlangen (DE); Alexander GÖTZ, Erlangen (DE); Christopher MUTSCHLER, Erlangen (DE)

(21) Appl. No.: 19/388,413

(22) Filed: Nov. 13, 2025

Related U.S. Application Data
(63) Continuation of application No. PCT/EP2024/063106, filed on May 13, 2024.

(30) Foreign Application Priority Data
May 14, 2023 (EP) 23173270.2

(51) Int. Cl. H04L 41/147; H04L 41/16

(52) U.S. Cl. CPC H04L 41/147; H04L 41/16

(57) ABSTRACT

An apparatus of a wireless communication system according to an embodiment is provided. The apparatus is configured to determine a metric for an AI/ML model of one or more inactive AI/ML models and/or for a functionality thereof, wherein the one or more inactive AI/ML models are suitable for supporting a task of a user equipment and/or of a network entity of the wireless communication system, the apparatus being the user equipment or being different from the user equipment; wherein the apparatus is configured to determine the metric for the AI/ML model and/or for the functionality thereof, such that the metric takes a benefit of employing the AI/ML model and/or the functionality thereof into account, and such that the metric takes an activation effort for activating the AI/ML model and/or the functionality thereof into account.

### CROSS-REFERENCE TO RELATED APPLICATIONS

This application is a continuation of copending International Application No. PCT/EP2024/063106, filed May 13, 2024, which is incorporated herein by reference in its entirety, and additionally claims priority from European Application No. 23173270.2, filed May 14, 2023, which is also incorporated herein by reference in its entirety.

The present invention relates to the field of wireless communication systems or networks, in particular to AI/IL enabled communication networks, and, more particularly to an apparatus and a method for performance prediction of models in AI/ML enabled communication networks.

### BACKGROUND OF THE INVENTION

FIG. 15 is a schematic representation of an example of a terrestrial wireless network 100 including, as is shown in FIG. 15(a), the core network and one or more radio access networks RAN₁, RAN₂, . . . RAN_{N} (RAN=Radio Access Network). FIG. 15(b) is a schematic representation of an example of a radio access network RANₙ that may include one or more base stations gNB₁ to gNB₅ (gNB=next generation Node B), each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT (Internet of Things) devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 15(b) shows an exemplary view of five cells, however, the RANₙ may include more or less such cells, and RAN₁ may also include only one base station. FIG. 15(b) shows two users UE₁ and UE₂, (UE=User Equipment) also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 15(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base stations gNB₁ to gNB₅ may be connected to the core network 102, e.g. via the S1 interface, via respective backhaul links 114₁ to 114₅, which are schematically represented in FIG. 15(b) by the arrows pointing to “core”. The core network 102 may be connected to one or more external networks. The external network may be the Internet or a private network, such as an intranet or any other type of campus networks, e.g. a private WiFi or 4G or 5G mobile communication system. Further, some or all of the respective base stations gNB₁ to gNB₅ may be connected, e.g. via the S1 or X2 interface or the XN interface in NR (New Radio), with each other via respective backhaul links 116₁ to 116₅, which are schematically represented in FIG. 15(b) by the arrows pointing to “gNBs”. A sidelink channel allows direct communication between UEs, also referred to as device-to-device, D2D (Device to Device), communication. The sidelink interface in 3GPP (3G Partnership Project) is named PC5 (Proximity-based Communication 5).

For data transmission a physical resource grid may be used. The physical resource grid may comprise a set of resource elements to which various physical channels and physical signals are mapped. For example, the physical channels may include the physical downlink, uplink and sidelink shared channels, PDSCH (Physical Downlink Shared CHannel), PUSCH (Physical Uplink Shared Channel), PSSCH (Physical Sidelink Shared Channel), carrying user specific data, also referred to as downlink, uplink and sidelink payload data, the physical broadcast channel, PBCH (Physical Broadcast Channel), carrying for example a master information block, MIB, and one or more of a system information block, SIB, one or more sidelink information blocks, SLIBs, if supported, the physical downlink, uplink and sidelink control channels, PDCCH (Physical Downlink Control Channel), PUCCH (Physical Uplink Control CHannel), PSCCH (Physical Sidelink Control Channel), the downlink control information, DCI, the uplink control information, UCI, and the sidelink control information, SCI, and physical sidelink feedback channels, PSFCH (Physical sidelink feedback channel), carrying PC5 feedback responses. Note, the sidelink interface may support a 2-stage SCI (Speech Call Items). This refers to a first control region comprising some parts of the SCI, and, optionally, a second control region, which comprises a second part of control information.

For the uplink, the physical channels may further include the physical random-access channel, PRACH (Packet Random Access Channel) or RACH (Random Access Channel), used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols (OFDM=Orthogonal Frequency-Division Multiplexing) depending on the cyclic prefix, CP, length. A frame may also include of a smaller number of OFDM symbols, e.g. when utilizing a shortened transmission time interval, sTTI (slot or subslot transmission time interval), or a mini-slot/non-slot-based frame structure comprising just a few OFDM symbols.

The wireless communication system may be any single-tone or multicarrier system using frequency-division multiplexing, like orthogonal frequency-division multiplexing, OFDM, or orthogonal frequency-division multiple access, OFDMA (Orthogonal frequency-division multiple access), or any other IFFT-based signal (IFFT=Inverse Fast Fourier Transformation) with or without CP, e.g. DFT-s-OFDM (DFT=discrete Fourier transform). Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 15 may be a heterogeneous network having distinct overlaid networks, e.g., a network of macro cells with each macro cell including a macro base station, like base stations gNB₁ to gNB₅, and a network of small cell base stations, not shown in FIG. 15, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 15, for example in accordance with the LTE-Advanced Pro standard or the 5G or NR, new radio, standard.

In mobile communication networks, for example in a network like that described above with reference to FIG. 15, like an LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, or roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

In a wireless communication network, like the one depicted in FIG. 15, it may be desired to locate a UE with a certain accuracy, e.g., determine a position of the UE in a cell. Several positioning approaches are known, like satellite-based positioning approaches, e.g., autonomous and assisted global navigation satellite systems, A-GNSS, such as GPS, mobile radio cellular positioning approaches, e.g., observed time difference of arrival, OTDOA, and enhanced cell ID, E-CID, or combinations thereof.

In the General AI/ML 3GPP SI, one of the ways that are envisioned to enable generalization of AI/ML solutions, is to switch between different models.

It would be highly appreciated if improved concepts for AI/ML enabled communication networks would be provided.

### SUMMARY

An embodiment may have an apparatus of a wireless communication system, wherein the apparatus is configured to determine a metric for an AI/ML model of one or more inactive AI/ML models and/or for a functionality thereof, wherein the one or more inactive AI/ML models are suitable for supporting a task of a user equipment and/or of a network entity of the wireless communication system, the apparatus being the user equipment or being different from the user equipment; wherein the apparatus is configured to determine the metric for the AI/ML model and/or for the functionality thereof, such that the metric takes a benefit of employing the AI/ML model and/or the functionality thereof into account, and such that the metric takes an activation effort for activating the AI/ML model and/or the functionality thereof into account, wherein the apparatus is configured to determine, depending on the metric for the AI/ML model and/or for the functionality thereof, whether or not to activate the AI/ML model and/or the functionality thereof.

Another embodiment may have an apparatus of a wireless communication system, wherein the apparatus is configured to activate an AI/ML model of one or more AI/ML models and/or a functionality thereof, wherein the one or more AI/ML models are suitable for supporting a task of a user equipment and/or of a network entity of the wireless communication system; wherein the apparatus is the user equipment or is different from the user equipment; wherein it depends on a metric of the AI/ML model and/or of a functionality thereof, if the AI/ML model and/or the functionality thereof is activated, wherein the metric takes a benefit of employing the AI/ML model and/or the functionality thereof into account, and wherein the metric takes an activation effort for activating the AI/ML model and/or the functionality thereof into account.

Another embodiment may have a user equipment of a wireless communication system, wherein the user equipment is configured to receive information on an output of an AI/ML model of one or more AI/ML models and/or of a functionality thereof from another apparatus of the wireless communication system, wherein the one or more AI/ML models are suitable for supporting a task of a user equipment and/or of a network entity of the wireless communication system; wherein it depends on a metric of the AI/ML model and/or of the functionality thereof, if the AI/ML model and/or the functionality thereof has been activated by the other apparatus, wherein the metric takes a benefit of employing the AI/ML model and/or the functionality thereof into account, and wherein the metric takes an activation effort for activating the AI/ML model and/or the functionality thereof into account.

According to another embodiment, a wireless communication system may have: an inventive apparatus of a wireless communication system, wherein the apparatus is configured to determine a metric for an AI/ML model of one or more inactive AI/ML models and/or for a functionality thereof, and the user equipment.

According to another embodiment, a wireless communication system may have: a first inventive apparatus, wherein the apparatus is configured to determine a metric for an AI/ML model of one or more inactive AI/ML models and/or for a functionality thereof, and a second inventive apparatus wherein the apparatus is configured to determine a metric for an AI/ML model of one or more inactive AI/ML models and/or for a functionality thereof, wherein the first apparatus is configured to select and/or to activate one of one or more AI/MVL models and/or to switch from one of the one or more AI/ML models to another one of the one or more AI/ML models depending on a selection and/or an activation of one of one or more AI/ML models of the second apparatus and/or depending on a switching from one of the one or more AI/ML models to another one of the one or more AI/ML models.

According to another embodiment, a method for a wireless communication system may have the steps of: determining a metric for an AI/ML model of one or more inactive AI/ML models and/or for a functionality thereof, wherein the one or more inactive AI/ML models are suitable for supporting a task of a user equipment and/or of a network entity of the wireless communication system, wherein the method is executed by the user equipment or by an apparatus of the wireless communication system being different from the user equipment; wherein determining the metric for the AI/ML model and/or for the functionality thereof is conducted, such that the metric takes a benefit of employing the AI/ML model and/or the functionality thereof into account, and such that the metric takes an activation effort for activating the AI/MVL model and/or the functionality thereof into account, determining, depending on the metric for the AI/ML model and/or for the functionality thereof, whether or not to activate the AI/ML model and/or the functionality thereof.

According to another embodiment, a method for a wireless communication system may have the step of: activating an AI/ML model of one or more AI/ML models and/or a functionality thereof; wherein the one or more AI/ML models are suitable for supporting a task of a user equipment and/or of a network entity of the wireless communication system; wherein the method is executed by the user equipment or by an apparatus of the wireless communication system being different from the user equipment; wherein it depends on a metric of the AI/ML model and/or of a functionality thereof, if the AI/NIL model and/or the functionality thereof is activated, wherein the metric takes a benefit of employing the AI/ML model and/or the functionality thereof into account, and wherein the metric takes an activation effort for activating the AI/ML model and/or the functionality thereof into account.

According to another embodiment, a method for a wireless communication system may have the step of receiving, by a user equipment, information on an output of an AI/ML model of one or more AI/ML models and/or of a functionality thereof from another apparatus of the wireless communication system, wherein the one or more AI/ML models are suitable for supporting a task of a user equipment and/or of a network entity of the wireless communication system; wherein it depends on a metric of the AI/ML model and/or of the functionality thereof, if the AI/ML model and/or the functionality thereof has been activated by the other apparatus, wherein the metric takes a benefit of employing the AI/ML model and/or the functionality thereof into account, and wherein the metric takes an activation effort for activating the AI/ML model and/or the functionality thereof into account.

Another embodiment may have a non-transitory digital storage medium having a computer program stored thereon to perform any of the inventive methods when said computer program is run by a computer.

An apparatus of a wireless communication system according to an embodiment is provided. The apparatus is configured to determine a metric for an AI/ML model of one or more inactive AI/ML models and/or for a functionality thereof, wherein the one or more inactive AI/ML models are suitable for supporting a task of a user equipment and/or of a network entity of the wireless communication system, the apparatus being the user equipment or being different from the user equipment; wherein the apparatus is configured to determine the metric for the AI/ML model and/or for the functionality thereof, such that the metric takes a benefit of employing the AI/ML model and/or the functionality thereof into account, and such that the metric takes an activation effort for activating the AI/ML model and/or the functionality thereof into account. Moreover, the apparatus is configured to determine, depending on the metric for the AI/ML model and/or for the functionality thereof, whether or not to activate the AI/ML model and/or the functionality thereof.

Moreover, an apparatus of a wireless communication system according to a further embodiment is provided. The apparatus is configured to activate an AI/ML model of one or more AI/ML models and/or a functionality thereof, wherein the one or more AI/ML models are suitable for supporting a task of a user equipment and/or of a network entity of the wireless communication system; wherein the apparatus is the user equipment or is different from the user equipment; wherein it depends on a metric of the AI/ML model and/or of a functionality thereof, if the AI/ML model and/or the functionality thereof is activated. The metric takes a benefit of employing the AI/ML model and/or the functionality thereof into account, and wherein the metric takes an activation effort for activating the AI/ML model and/or the functionality thereof into account.

Furthermore, a user equipment of a wireless communication system according to another embodiment is provided. The user equipment is configured to receive information on an output of an AI/ML model of one or more AI/ML models and/or of a functionality thereof from another apparatus of the wireless communication system, wherein the one or more AI/ML models are suitable for supporting a task of a user equipment and/or of a network entity of the wireless communication system. It depends on a metric of the AI/ML model and/or of the functionality thereof, if the AI/ML model and/or the functionality thereof has been activated by the other apparatus, wherein the metric takes a benefit of employing the AI/ML model and/or the functionality thereof into account, and wherein the metric takes an activation effort for activating the AI/ML model and/or the functionality thereof into account.

Moreover, a method for a wireless communication system according to an embodiment is provided. The method comprises determining a metric for an AI/ML model of one or more inactive AI/ML models and/or for a functionality thereof, wherein the one or more inactive AI/ML models are suitable for supporting a task of a user equipment and/or of a network entity of the wireless communication system, wherein the method is executed by the user equipment or by an apparatus of the wireless communication system being different from the user equipment; wherein determining the metric for the AI/ML model and/or for the functionality thereof is conducted, such that the metric takes a benefit of employing the AI/ML model and/or the functionality thereof into account, and such that the metric takes an activation effort for activating the AI/ML model and/or the functionality thereof into account. Moreover, the method comprises determining, depending on the metric for the AI/ML model and/or for the functionality thereof, whether or not to activate the AI/MVL model and/or the functionality thereof.

Furthermore, a method for a wireless communication system according to an embodiment is provided. The method comprises activating an AI/MHL model of one or more AI/ML models and/or a functionality thereof, wherein the one or more AI/ML models are suitable for supporting a task of a user equipment and/or of a network entity of the wireless communication system; wherein the method is executed by the user equipment or by an apparatus of the wireless communication system being different from the user equipment; wherein it depends on a metric of the AI/ML model and/or of a functionality thereof, if the AI/ML model and/or the functionality thereof is activated. The metric takes a benefit of employing the AI/ML model and/or the functionality thereof into account, and wherein the metric takes an activation effort for activating the AI/ML model and/or the functionality thereof into account.

Moreover, a method for a wireless communication system according to an embodiment is provided. The method comprises receiving, by a user equipment, information on an output of an AI/ML model of one or more AI/ML models and/or of a functionality thereof from another apparatus of the wireless communication system, wherein the one or more AI/ML models are suitable for supporting a task of a user equipment and/or of a network entity of the wireless communication system. It depends on a metric of the AI/ML model and/or of the functionality thereof, if the AI/ML model and/or the functionality thereof has been activated by the other apparatus, wherein the metric takes a benefit of employing the AI/ML model and/or the functionality thereof into account, and wherein the metric takes an activation effort for activating the AI/ML model and/or the functionality thereof into account.

Furthermore, a computer program for implementing the method of one of above-described methods when the computer program is executed by a computer or signal processor according to an embodiment is provided.

A set of examples for models that are trained for different areas is shown in FIG. 1.

FIG. 1 illustrates different regions/scenarios according to embodiments, where model selection/switching is needed. Shaded areas indicate model overlap.

Here a moving UE starts from area A and has model A activated. As the UE moves, a decision on whether to keep using the specific model or switch to another model needs to be made in the shaded regions. Especially for the upper right scenario, there is a chance that switching from model A to model B might not be sufficient and a new model needs to be trained for the shaded region.

Different models can be defined not only for spatially different areas, but also for different values of SNR, UE speed, etc. as shown in FIG. 2.

FIG. 2 illustrates different operating conditions/scenarios according to embodiments, where model selection/switching is needed. Shaded areas indicate model overlap.

FIG. 2a illustrates different cells according to embodiments, where model/functionality selection/switching is needed.

In particular, FIG. 2a illustrates an example of mobility management within 3GPP discussion. Here, as the UE moves from the coverage area of a (source) cell towards the (possibly overlapping) coverage area of one or more (target) cells, a decision needs to be made on which target gNB the UE will connect to—a process known as handover.

Several handover management mechanisms have been defined, including “legacy” handover, conditional handover (CHO), LTM and DAPS. What is common in all of them, is that a decision needs to be made for the UE to connect to a target gNB in an efficient and seamless manner, without experiencing any QoS drop or radio link failures.

This becomes more complicated when combined with AI/ML support (as discussed within 3GPP) for use cases like beam management, CSI compression/prediction and positioning. For example, let's assume that the UE shown in FIG. 1 has an active AI/ML model that performs beam management. Let's also assume that the active model performs as expected (achieves the set performance target/constraint) in certain areas (e.g. Cells 1 and 2), but for beam management in other areas (e.g. Cell 3), a different model (or functionality) is needed for fulfilling the performance target. In this case, on top of the typical measurements for handover management (e.g., received RSRP), a prediction on the estimated performance of models/functionalities in target cells, is also crucial.

Finally, even for the same area and the same conditions, different implementations of models addressing the same functionality (appear with the same model ID to the network) might be available. Here, the monitoring entity can decide to switch between models depending, e.g., on expected performance vs model complexity (see FIG. 3).

In some cases, the monitoring entity may need some configurations of downlink reference signals to be received by the UE or uplink reference signals to be transmitted by the UE, in addition to or instead of the reference signals the UE is currently transmitting or receiving. Similarly, in some cases, an inactive ML model may need some configurations of downlink reference signals to be received by the UE or uplink reference signals to be transmitted by the UE, in addition to or instead of the reference signals the UE is currently transmitting or receiving. In such situations, the UE may request the network to transmit certain configuration of reference signals to be transmitted by the network.

In some cases, the request for the UE to transmit or receive may be sent by the network:
1) The network entity indicates to the UE one or more configurations of reference signals that the UE may be expected to receive and or transmit, through a higher layer signalling mechanism, such as RRC signalling or LPP signalling.
2) The network entity indicates to the UE via reconfiguration or lower layer trigger to initiate reception or transmission of such signals. For example, the new configuration may be provided by RRC-Reconfiguration or new LPP message ProvideAssistanceData. Alternatively, a MAC-CE or physical layer DCI or sidelink DCI may be used to indicate the UE to receive or transmit such signalling. Alternatively, the MAC-CE may be used to switch inactive models and also indicate the UE to receive or transmit signals again.

In some cases, the UE may decide (due its internal implementation or subject to higher layer trigger or trigger from another entity) to receive additional downlink reference signals from at least one network entity. The UE may need to perform measurement on certain downlink reference signals for inference or monitoring purposes. However, if the network is not actively transmitting a reference signal that the UE needs, the UE may:
1) Request the network entity to transmit a reference signal, indicating either an identifier identifying a configuration of reference signal from a plurality of reference signal configuration indicated to the UE.
   Or:
   Request the network entity to transmit a reference signal and/or request the NW to provide the UE with an on-demand configuration for a reference signal that the UE can receive, indicating at least one parameter describing the reference signal, such as periodicity, bandwidth, subcarrier spacing, spatial direction, etc.
2) Perform the measurement on the reference signal transmitted by the network.
3) Monitor the performance of an active ML model and/or at least one inactive ML model.

The network may have provided configurations and/or assistance data indicating certain configuration of reference signals may be requested for AI/ML monitoring.

### BRIEF DESCRIPTION OF THE DRAWINGS

Embodiments of the present invention will be detailed subsequently referring to the appended drawings, in which:

FIG. 1 illustrates different regions/scenarios according to embodiments, where model selection/switching is needed.

FIG. 2 illustrates different operating conditions/scenarios according to embodiments, where model selection/switching is needed.

FIG. 2a illustrates different cells according to embodiments, where model/functionality selection/switching is needed.

FIG. 3 illustrates model/functionality relations in 3GPP.

FIG. 4 illustrates a model-switching scenario.

FIG. 5 illustrates a calculation of a performance benefit and cost of a model activation or switching decision according to an embodiment.

FIG. 6 illustrates data collected from model selection/activation/deactivation/switching from several UEs in the same area at different times according to embodiments.

FIG. 7 illustrates a scenario, where model A is activated in the overlapping AB area according to an embodiment.

FIG. 8 illustrates a second scenario according to an embodiment, where model Z is activated in the overlapping AB area.

FIG. 9 illustrates a model switching operation in a two-sided operation according to an embodiment.

FIG. 10 illustrates an example representation of a 3GPP network depicting representative functional blocks.

FIG. 11 illustrates transmissions of a number of inference devices in a wireless communications system according to an embodiment.

FIG. 12 illustrates transmission from an inference device in a wireless communication system according to an embodiment.

FIG. 13 illustrates a mechanism of combining labelled data from an inference data with ground truth obtained from one or more sources to obtain labelled data for training a model and/or a functionality and/or a performance indicator.

FIG. 14 illustrates a flow chart for providing one or more AI/ML models from the network to a user equipment according to another embodiment.

FIG. 15 illustrates a schematic representation of an example of a terrestrial wireless network.

FIG. 16 illustrates an example of a computer system on which units or modules as well as the steps of the methods described in accordance with the inventive approach may execute.

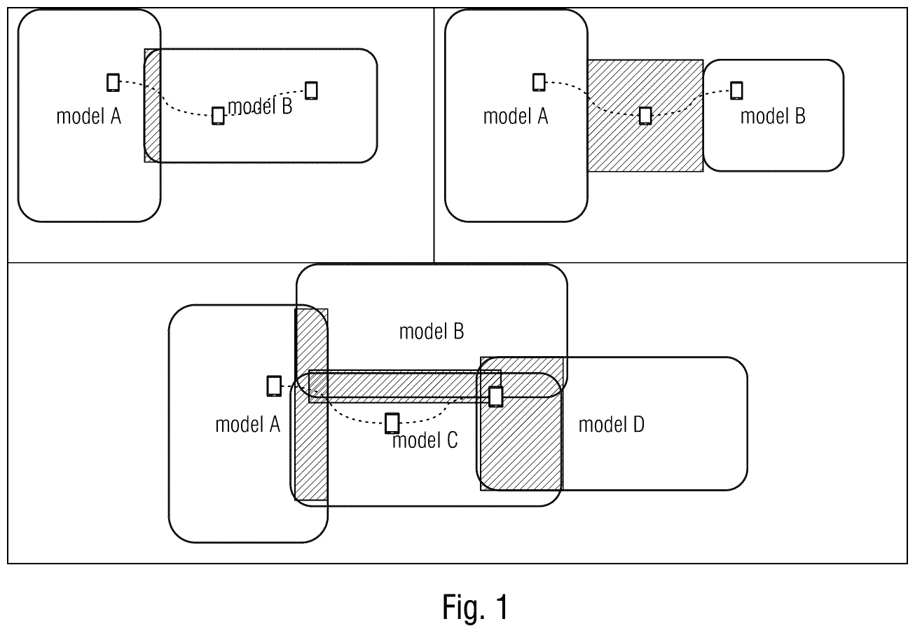

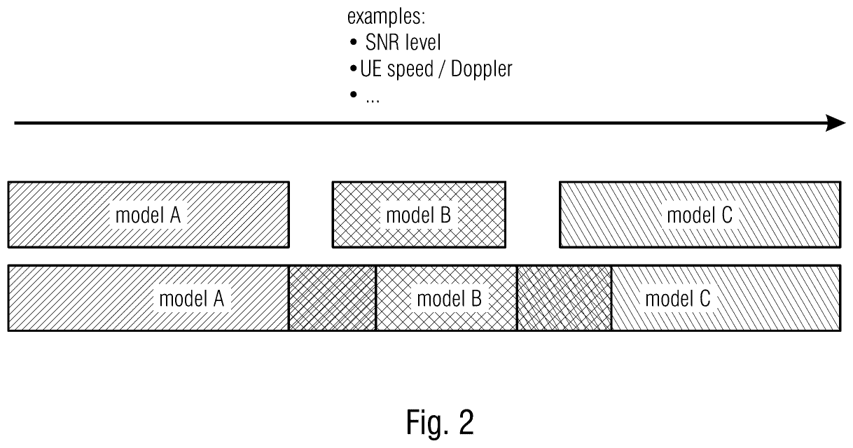

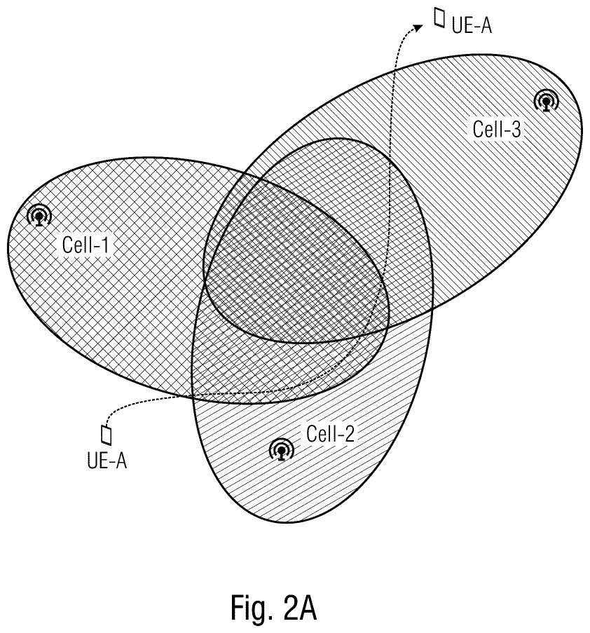

### DETAILED DESCRIPTION OF THE INVENTION

An apparatus of a wireless communication system according to an embodiment is provided.

The apparatus is configured to determine a metric for an AI/ML model of one or more inactive AI/ML models and/or for a functionality thereof, wherein the one or more inactive AI/ML models are suitable for supporting a task of a user equipment and/or of a network entity of the wireless communication system, the apparatus being the user equipment or being different from the user equipment; wherein the apparatus is configured to determine the metric for the AI/ML model and/or for the functionality thereof, such that the metric takes a benefit of employing the AI/ML model and/or the functionality thereof into account, and such that the metric takes an activation effort for activating the AI/ML model and/or the functionality thereof into account.

Moreover, the apparatus is configured to determine, depending on the metric for the AI/ML model and/or for the functionality thereof, whether or not to activate the AI/ML model and/or the functionality thereof.

According to an embodiment, the apparatus may, e.g., be configured to activate the AI/ML model, if the apparatus has determined that the AI/ML model shall be activated.

In an embodiment, the apparatus may, e.g., be the user equipment; and the apparatus may, e.g., be configured to employ the AI/ML model to perform the task, if the apparatus has determined that the AI/ML model shall be activated.

According to an embodiment, the apparatus may, e.g., be different from the user equipment; and the apparatus may, e.g., be configured to transmit information to the user equipment to activate the AI/ML model, if the apparatus has determined that the AI/ML model shall be activated. Or, the apparatus may, e.g., be configured to transmit information to another apparatus of the wireless communication system to activate the AI/ML model, if the apparatus has determined that the AI/ML model shall be activated.

According to an embodiment, the term ‘functionality’ may, for example, refer to a specific configuration, input, or output of an AI/ML model within the apparatus. There the term may, for example, relate to at least one functionality that includes an AI/ML model. Each functionality may, for example, incorporate one or more models, and may, for example, be distinguished from another functionality by having at least one difference in its configuration, input, or output. For example, models with the same configuration, input, and output may, for example, be considered part of the same functionality. The configurations within the functionalities may, for example, encompass various elements such as network signaling configuration, training configuration, monitoring configuration, reporting configuration, and other relevant parameters.

In an embodiment, which relates to an operation with a same functionality, the solution may, for example, focus on managing AI/ML models within the same functionality. The apparatus may, e.g., determine or, may, e.g., be configured to determine a metric for an AI/MVL model between multiple models thereof within the same functionality, wherein the AI/MVL models within the same functionality may, for example, share a common configuration, input, and output. The apparatus may, e.g., further be configured to evaluate the benefits of employing the AI/ML models within the same functionality and the activation effort needed for each model. Based on the determined metric, the apparatus may, for example, decide whether to activate or deactivate the AI/ML models within the same functionality, considering the overall benefit and effort involved.

In another embodiment, the solution may, for example, involve the management of multiple interconnected AI/ML models within the same functionality. The apparatus may, e.g., determine or may, e.g., be configured to determine a metric for a set of interconnected AI/ML models within the same functionality, wherein the interconnected models collaborate to perform a specific task. The apparatus may, e.g., be further configured to consider the benefits of employing the interconnected AI/ML models and the activation effort needed for each individual model. Based on the metric, the apparatus may, e.g., decide whether to activate or to deactivate the set of interconnected AI/ML models within the same functionality, taking into account the collective benefit and effort involved in utilizing the interconnected models. The activation or deactivation of any individual AI/MVL model within the set may, e.g., impact the overall performance and functionality of the interconnected models.

In a further embodiment relating to an operation between different functionalities, the solution may, e.g., support an operation between different functionalities, where at least one functionality may, e.g., be AI/ML feature-enabled. The apparatus may, e.g., determine or may, e.g., be configured to determine a metric for an AI/ML model and/or a functionality thereof within the current functionality, wherein the current functionality does not include an AI/ML feature-enabled functionality. The apparatus may, e.g., evaluate the benefits of employing the AI/ML models and/or functionalities within the current functionality and the activation effort needed for each model and/or functionality. The apparatus may, e.g., determine a metric for an AI/ML model and/or a functionality thereof within a target functionality, wherein the target functionality includes at least one AI/ML feature-enabled functionality. The apparatus may, e.g., evaluate the benefits of employing the AI/ML models and/or functionalities within the target functionality and the activation effort needed for each model and/or functionality; and may, e.g., decide whether to activate the target functionality based on the determined metrics and evaluated benefits and activation efforts, considering the overall improvement and effort involved in activating the AI/ML feature-enabled functionality.

In another embodiment, the solution may, e.g., support an operation between different functionalities, where at least one functionality may, e.g., be AI/ML feature-enabled. The apparatus may, e.g., determine or may, e.g., be configured to determine a metric for an AI/ML model and/or a functionality thereof within the current functionality, wherein the current functionality may, e.g., include an AI/ML feature-enabled functionality.

In an embodiment, the apparatus may, e.g., be configured to determine the metric for the AI/ML model and/or for the functionality thereof, such that the metric takes a benefit and/or a cost of deactivating a presently employed AI/MVL model and/or a presently employed functionality thereof into account.

According to an embodiment, the apparatus may, e.g., be configured to determine the metric for the AI/ML model and/or for the functionality thereof, such that the metric takes a benefit and/or a cost of switching from a presently employed AI/ML model and/or a presently employed functionality thereof to said AI/ML model and/or to said functionality thereof into account.

In an embodiment, the apparatus may, e.g., be configured to determine, depending on the metric for the AI/ML model and/or for the functionality thereof, if the AI/ML model and/or the functionality thereof may, e.g., be to be activated or if a non-AI/ML (e.g., legacy) functionality shall be employed, e.g., as a fallback.

According to an embodiment, the activation effort for activating the AI/ML model and/or the functionality thereof comprises one or more of the following:
a computational cost, e.g. number of processing cycles, number of multiplications, etc.,
a signaling cost, e.g. data volume of signaling messages to be exchanged, e.g., between the user equipment and a unit of the wireless communication system,
an activation time for activating the model, etc.,
an increase of a latency,
a monitoring cost,
a combination thereof.

According to an embodiment, the activation effort for activating the AI/ML model and/or the functionality thereof may, e.g., comprise the monitoring cost, wherein the monitoring cost may, e.g., depend on an availability of ground truth labels and/or PRUs and/or may, e.g., depend on how frequent measurements of all the beams in the codebook in beam management are conducted.

Regarding monitoring costs, one of the costs associated with the LCM of AI/ML models is the cost of monitoring. What this practically means, is that for model performance monitoring, certain overhead is induced for measurements/signaling or even availability of resources (e.g., the availability of PRUs for ground truth labels in positioning or frequent measurement of all the beams in the codebook in beam management).

Different models/functionalities might have different monitoring requirements. For example, a monitoring configuration for monitoring the input/output of a model to determine if it is close to the training data distribution can have minimal overhead compared to a different monitoring configuration that facilitates measuring all beams in the codebook in frequent time intervals.

Consequently, it is possible that even though a model/functionality is predicted to be the best performing one, it might not be selected for activation due to stringent monitoring requirements. Alternatively, it might be activated only under specific monitoring configurations.

In an embodiment, the apparatus may, e.g., be configured to determine the metric for the AI/ML model and/or for the functionality thereof depending on at least one of the following:
information on which functionality/model is active now and its properties,
information on the performance or associated QoS of the current active functionality/model,
information on a cell ID, and/or an area ID, and/or a dataset ID,
potential performance requirements and/or cost constraints,
input data of the AI/ML model which is currently employed,
measurements that are related to the applicable conditions of the functionality, e.g., SNR levels, UE speed, Doppler, beam codebook type, PRS identity, model pairing information for two-sided models, and/or, e.g., a network synchronization error, and/or, e.g., a UE/gNB RX and TX timing error,
information on alarms from other model monitoring entities, and/or results of monitoring metric calculations in general from other model monitoring entities,
information on the amount of time the current active model has been activated,
high-level features/post-processed information on the UE state, for example, UE orientation/position/velocity, predicted future UE trajectory,
side information from the network, on the general properties of the radio environment, reported problems from other UEs.

Regarding the aspect of Cell/Area/Dataset ID as input to the estimator, a model may, e.g., be trained using any mix of data from collected datasets from various cells/areas. It is reasonable to assume that then the model would perform as expected in these cells/areas, as long as the radio/environment properties have not changed. Therefore, the Cell/Area/Dataset ID as input to the estimator can indicate whether a model (and as consequence, a functionality supported by the model) is expected to perform adequately within some set performance targets/constraints).

According to an embodiment, the one or more AI/ML models comprise two or more AI/ML models.

In an embodiment, the apparatus may, e.g., be the user equipment. The apparatus may, e.g., be configured to select and/or to activate one of the two or more AI/ML models and/or to switch from one of the two or more AI/ML models to another one of the two or more AI/ML models depending on which of at least two AI/ML models is activated at a network unit of the wireless communication system.

According to an embodiment, the apparatus may, e.g., be the user equipment. The apparatus may, e.g., be configured to receive information on rules from a network unit of the wireless communication system, wherein the information relates to select and/or to activate one of the two or more AI/ML models and/or to switch from one of the two or more AI/ML models to another one of the two or more AI/ML models.

In an embodiment, the apparatus may, e.g., be the user equipment. The apparatus may, e.g., be configured to request allowance from a network unit of the wireless communication system to select and/or to activate one of the two or more AI/ML models and/or to switch from one of the two or more AI/ML models to another one of the two or more AI/ML models. Moreover, the apparatus may, e.g., be configured, when receiving the allowance from the network unit to select and/or to activate said one of the two or more AI/ML models and/or to switch from one of the two or more AI/ML models to said other one of the two or more AI/ML models.

According to an embodiment, the apparatus may, e.g., be the user equipment. The apparatus may, e.g., be configured to select and/or to activate one of the two or more AI/MVL models and/or to switch from one of the two or more AI/ML models to another one of the two or more AI/ML models depending on selection information received from a network unit of the wireless communication system.

In an embodiment, the apparatus may, e.g., be configured to determine the performances of one or more AI/MVL models for supporting the task of the user equipment and/or of the network entity depending on a current position of the user equipment.

According to an embodiment, each of the two or more AI/MVL models may, e.g., be applicable for a geographical region. If the current position of the user equipment is located in a geographical region, where two AI/ML models of the two or more AI/ML models are applicable, the apparatus may, e.g., be configured to determine, if a first one or if a second one of the two AI/ML models is to be activated by determining a metric for each of the two AI/ML models. For each A/ML model of the two AI/ML models, the metric of the AI/ML model takes a benefit of employing the AI/ML model and/or the functionality thereof into account, and wherein the metric takes an activation effort for activating the AI/ML model and/or the functionality thereof into account.

In an embodiment, the apparatus may, e.g., be the user equipment. The apparatus may, e.g., be configured to determine the metric for each of the two AI/ML models, if the apparatus has determined that it is located in a geographical region, where the two AI/ML models are applicable.

According to an embodiment, the apparatus may, e.g., be different from the user equipment. The apparatus may, e.g., be configured to receive information from the user equipment that the user equipment is located in a geographical region where the two AI/MVL models are applicable. Moreover, the apparatus may, e.g., be configured to determine the metric for each of the two AI/ML models in response to receiving the information.

In an embodiment, the apparatus may, e.g., be configured to determine the metric for each AI/ML model of the two or more AI/ML models and/or for a functionality thereof depending on a characteristic of a current environment of the user equipment.

According to an embodiment, the apparatus may, e.g., be configured to determine the metric for each AI/ML model of the two or more AI/ML models and/or for a functionality thereof depending on a characteristic of the user equipment and/or depending on a characteristic of the network entity.

In an embodiment, the apparatus may, e.g., be configured to determine the metric for each AI/ML model of the two or more AI/ML models and/or for a functionality thereof depending on a state of a battery power of a user equipment and/or depending on an active battery power saving mode.

According to an embodiment, the apparatus may, e.g., be configured to determine the metric for each AI/ML model of the two or more AI/ML models and/or for a functionality thereof depending on a transmission characteristic of a transmission between the user equipment and the network and/or depending on a transmission characteristic of a transmission between the user equipment and another user equipment and/or depending on radio environment properties.

In an embodiment, the apparatus may, e.g., be configured to determine the metric for each AI/ML model of the two or more AI/ML models and/or for a functionality thereof depending on a current state of the user equipment and depending on one or more possible future states of the user equipment.

According to an embodiment, the apparatus may, e.g., be configured to determine the metric for each AI/ML model of the two or more AI/ML models and/or for a functionality thereof depending on two or more possible future actions of the user equipment.

In an embodiment, the apparatus may, e.g., be configured to determine the metric for each AI/ML model of the two or more AI/ML models and/or for a functionality thereof depending on a reward function that returns a real value indicating a performance of one of the two or more AI/ML models (for example, when conducting one of the two or more possible future actions when the user equipment is in a state, the state being one of the current state and the one or more future states).

According to an embodiment, the reward function returns one of the following values:
for beam management, a value indicating performance, for example, indicating a top-K accuracy of the AI/MHL model or a system throughput achieved with a selected beam,
for CSI compression, a value indicating performance, for example, indicating a throughput or a similarity between a decoder output and a target CSI,
for direct/assisted positioning, a value, for example, indicating a prediction accuracy, for example, as evaluated by a PRU capable of generating ground truth labels.

In an embodiment, the apparatus may, e.g., be configured to determine the metric for each AI/ML model of the two or more AI/ML models and/or for a functionality thereof depending on a cost function that takes the effort or the computational cost for activating a particular AI/ML model of the one or more AI/ML models into account, and/or takes the effort or the computational cost for activating a functionality of the particular AI/ML model into account, and/or takes the effort or the computational cost for switching from a current AI/ML model of the one or more AI/ML models to another AI/ML model of the one or more AI/MHL models into account.

According to an embodiment, the apparatus may, e.g., be configured to determine the metric for each AI/ML model of the two or more AI/ML models and/or for a functionality thereof depending on the reward function and depending on the cost function.

In an embodiment, the apparatus may, e.g., be configured to determine the metric for each AI/ML model of the two or more AI/ML models and/or for a functionality thereof by determining a linear combination of the reward function and of the cost function.

According to an embodiment, the reward function returns a value that penalizes switching from one of the two or more AI/ML models to another one of the two or more AI/ML models.

In an embodiment, the reward function returns a value that penalizes a repeatedly conducted switching from one of the two or more AI/ML models to another one of the two or more AI/ML models.

According to an embodiment, the cost function returns a value that penalizes switching from one of the two or more AI/ML models to another one of the two or more AI/ML models.

In an embodiment, the cost function returns a value that penalizes a repeatedly conducted switching from one of the two or more AI/ML models to another one of the two or more AI/ML models.

According to an embodiment, each of the one or more AI/ML models are implemented by one or more neural networks.

In an embodiment, the task may, e.g., be a positioning task of the user equipment and/or of the network entity.

According to an embodiment, the task may, e.g., be a management task or a configuration task or of the user equipment and/or of the network entity, for example, a beam management task of the user equipment and/or of the network entity.

In an embodiment, the task may, e.g., be a coding task of the user equipment and/or of the network entity or may, e.g., be a compression task of the user equipment and/or of the network entity, for example, a task for compressing channel state information.

Moreover, an apparatus of a wireless communication system according to a further embodiment is provided.

The apparatus is configured to activate an AI/ML model of one or more AI/ML models and/or a functionality thereof, wherein the one or more AI/ML models are suitable for supporting a task of a user equipment and/or of a network entity of the wireless communication system; wherein the apparatus is the user equipment or is different from the user equipment; wherein it depends on a metric of the AI/ML model and/or of a functionality thereof, if the AI/ML model and/or the functionality thereof is activated.

The metric takes a benefit of employing the AI/ML model and/or the functionality thereof into account, and wherein the metric takes an activation effort for activating the AI/ML model and/or the functionality thereof into account.

According to an embodiment, the apparatus implements an apparatus according to one of the above-described embodiments.

In an embodiment, the apparatus does not implement an apparatus according to one of the above-described embodiments, but the apparatus may, e.g., be configured to receive information on the AI/ML model of one or more AI/ML models that is to be activated from an apparatus according to one of the above-described embodiments.

According to an embodiment, the apparatus may, e.g., be the user equipment.

In an embodiment, the apparatus is, for example, not the user equipment, but the apparatus may, e.g., be configured to provide an output from the AI/ML model to the user equipment and/or to the network entity to support the user equipment and/or the network entity to perform the task.

Furthermore, a user equipment of a wireless communication system according to another embodiment is provided.

The user equipment is configured to receive information on an output of an AI/ML model of one or more AI/ML models and/or of a functionality thereof from another apparatus of the wireless communication system, wherein the one or more AI/ML models are suitable for supporting a task of a user equipment and/or of a network entity of the wireless communication system.

It depends on a metric of the AI/ML model and/or of the functionality thereof, if the AI/ML model and/or the functionality thereof has been activated by the other apparatus, wherein the metric takes a benefit of employing the AI/ML model and/or the functionality thereof into account, and wherein the metric takes an activation effort for activating the AI/ML model and/or the functionality thereof into account.

According to an embodiment, the other apparatus may, e.g., be an apparatus according to one of the above-described embodiments.

Moreover, a wireless communication system is provided, which comprises an apparatus according to one of the above-described embodiments and the user equipment.

According to an embodiment, the wireless communication system further comprises a further apparatus according to one of the above-described embodiments.

In an embodiment, the user equipment may, e.g., be a user equipment according to one of the above-described embodiments.

Furthermore, a wireless communication system is provided, which comprises a first apparatus according to one of the above-described embodiments and a second apparatus according to one of the above-described embodiments. The first apparatus is configured to select and/or to activate one of one or more AI/ML models and/or to switch from one of the one or more AI/ML models to another one of the one or more AI/ML models depending on a selection and/or an activation of one of one or more AI/ML models of the second apparatus and/or depending on a switching from one of the one or more AI/ML models to another one of the one or more AI/ML models.

Before further embodiments of the present invention are provided, some background information is provided.

In a 5G AI/ML framework, in the context of machine learning, life cycle management LCM refers to the end-to-end process of developing, deploying, and maintaining machine learning models. This includes several stages, such as data preparation, model training, testing, deployment, monitoring, and maintenance. For the context of the proposed solution we focus on the stages in the LCM relevant for the landmark utilization.

Data collection is defined in 3GPP Framework as a process of collecting data by the network nodes, management entity, or UE for the purpose of AI/MVL model training, data analytics and inference. Data Collection and Preparation involves the collection and preparation of data by the UE, the Network, or outside the network (for example non-3GPP entity). The data is used to train the machine learning model in offline or in real time.

Model Training is defined as a process to train an AI/ML Model by learning the input/output relationship in a data driven manner and obtain the trained AI/ML Model for inference: In this stage, the machine learning model is trained using the prepared data. This involves selecting the right algorithms and optimizing the model's performance.

Model validation is defined subprocess of training, to evaluate the quality of an AI/ML model using a dataset different from one used for model training, which helps selecting model parameters that generalize beyond the dataset used for model training.

Model testing is defined subprocess of training, to evaluate the performance of a final AI/ML model using a dataset different from one used for model training and validation. Differently from AI/ML model validation, testing does not assume subsequent tuning of the model.

Model monitoring is defined as a procedure that monitors the inference performance of the AI/ML model. Once the model is deployed, it needs to be continuously monitored to detect any performance degradation or errors. This stage involves tracking model performance (monitoring) metrics, detecting data drift, and retraining the model if needed.

Model Maintenance: the model needs to be maintained and updated over time to ensure its performance remains optimal. This stage involves retraining the model with new data, upgrading its algorithms, and improving its architecture.

An active model may, e.g., be understood as the (AI/ML) model used currently for inference.

Inactive models may, e.g., be understood as all available models that the UE could use.

Candidate models for activation may, e.g., be understood as models that could potentially perform equally well or better than the current active model.

Functionality identification, according to 5G framework may, e.g., be understood as a process/method of identifying an AI/ML functionality for the common understanding between the NW and the UE.

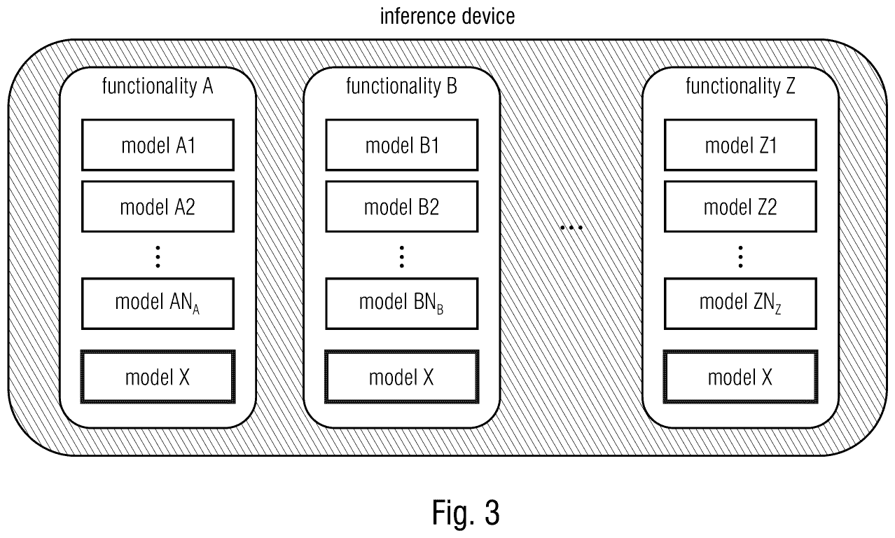

UE may have one AI/ML model for the functionality, or UE may have multiple AI/ML models for the functionality (e.g., see functionalities A, B, Z in FIG. 3). Models of the same functionality, albeit maybe different in structure, will have the same input/output/side-information configuration.

Alternatively, a more complex model, trained with data from several sites, can implement more than one functionality (e.g., see Model X in FIG. 3). In this case, proper configuration of the model and the signaling between the UE and the NW is needed to handle the different input/output/side-information requirements.

For functionality-based LCM procedure on the UE-part/UE-side models the UE can in one option provide indication of activation/deactivation/switching/fallback based on individual AI/ML functionality. The UE may receive assistance data to enable this functionality. The UE can in an alternating option receive from a second entity, such a coordinating entity, an indication of activation/deactivation/switching/fallback based on individual AI/MVL functionality. For the later option the second entity being a network indicates activation/deactivation/fallback/switching of AI/ML functionality via 3GPP signaling (e.g., RRC, MAC-CE, DCI).

FIG. 3 illustrates model/functionality relations in 3GPP.

An AI/ML model may, e.g., have a model ID with associated/meta information at least for some AI/ML operations when network needs to be aware of UE AI/ML models. For model-ID-based LCM procedure, indication of model selection/activation/deactivation/switching/fallback is based on individual model IDs.

Model description information or meta information is the supplemental information being provided about a model during model identification process. The model description information can include a list of applicable AI/ML-enabled Feature(s) and/or applicable conditions of the model. The conditions can for example include the applicable functionality/functionalities, applicable RRC configurations, model pairing ID.

Different model implementations are available for the same functionality. For example, in some embodiments, if the AI/ML model is implemented as a neural network, such a neural network may, e.g., comprise at least one of a fully connected layer, a pooling layer, and convolutional layer. According to some embodiments, for example, a dense network may, e.g., be employed. In some embodiments, for example, weight pruning and/or node pruning may, e.g., be employed.

It has already been discussed for the purpose of model activation/selection/switching, to study a necessity, feasibility and potential (specification) impact for methods to evaluate the applicability of inactive AI/ML models/functionalities, including the following examples:

An evaluation by comparing the model's applicability condition to the current conditions. These are the “static” conditions, like area ID, SNR level, UE speed, etc.

An evaluation based on input data distribution. This can be: It is noticed that the data being measured, seems to be the training data used to train the model, so the model should perform well here.

An evaluation through model monitoring by using the inactive model(s) for monitoring purpose and measuring the inference accuracy/system performance. This can be understood as: Load the inactive model(s), feed it(them) with the input data and record its(their) output. If an inactive model appears to perform better compared to the current active model (based on the outputs of all models), switch to this one.

An open question remained how to mitigate resulting system performance impact if any. The question is: can one predict if an inactive model is more suitable, without running everything in parallel?

An evaluation through model monitoring by using the inactive model(s) for monitoring purpose and measuring the inference accuracy/system performance, can have several shortcomings:

Loading inactive models in parallel and performing inference is computationally expensive for the UE.

Determining if inactive model(s) are better than the active model, could need getting ground truth labels for monitoring purposes.

If the UE is in a sub-region or a set of conditions that more than one models can be applied, there is the chance/danger that we are stuck at a constant model switching.

Loading inactive models that perform the same task (so they can be activated under the same applicable conditions) but have different implementations (e.g., Transformers vs CNN, smaller/larger models, etc.) or belong to different functionalities (so might need different inputs) is still challenging.

In the following, particular embodiments are provided.

Embodiments relate to an evaluation of the applicability of inactive AI/ML models/functionalities.

Instead of loading candidate inactive models and running them in parallel, embodiments construct an estimator that for selected inactive functionalities/models it predicts the expected benefit of activating the functionality/model, taking into account the expected performance/QoS the model will bring, as well as the cost due to selection/activation/deactivation/switching to the candidate functionality/model.

It is observed that taking into account the performance/cost trade-off, model selection/activation/deactivation/switching can be implemented with several options, for example, as follows:
The model with the best performance may, e.g., be utilized, regardless of the associated cost.
A performance requirement may, e.g., be provided. The performance estimator may, e.g., be queried and a list of candidate models that would be expected to fulfill the performance constraint is compiled. The final model to be activated may, e.g., be the one on this list with the smallest expected cost according to the cost estimator.
A maximum acceptable cost may, e.g., be provided. The cost estimator may, e.g., be queried and a list of candidate models that would be expected to fulfill the cost constraint may, e.g., be compiled. The final model to be activated may, e.g., be the one on this list with the highest expected performance according to the performance estimator.

In the following, a summary of an embodiment is provided.

According to an embodiment, a method for predicting/estimating the expected benefit of a machine learning (ML) model/functionality by the inference device, the device supports plurality of ML model/functionality, is provided. The method comprises
selecting a set of the applicable model/functionality from the supported ML model/functionality; and
estimating the expected performance and/or cost of the selected models in addition or instead of the active model or for the selection of an initial model;
   deciding by the device to activate or switch an ML model/functionality; or
   providing information on the estimated expected benefit to a second device to enable the second device make a decision on the model activation/switching for the inference device and/or other inference devices with similar functionalities.

An expected benefit of some of the embodiments, depends on short, mid and long term which avoids glitches and costly switches despite performance gain.

According to embodiments, the inference device may, e.g., be single or two-sided.

In some embodiments, the selection step may, e.g., be conducted by the device or the NW or both.

According to some embodiments, the estimation step may, e.g., be conducted by using data from successful and failed model switches (“successful in the next period”)

In an embodiment, modeling the problem as an MDP on the multiple partitions to weight costs/risks may, e.g., be conducted.

According to an embodiment, receiving information/QoS/strategy for operation on the multiple partitions to train or configure weight data may, e.g., be conducted.

In the following, technical details of some particular embodiments are provided.

At first, an operation example is described.

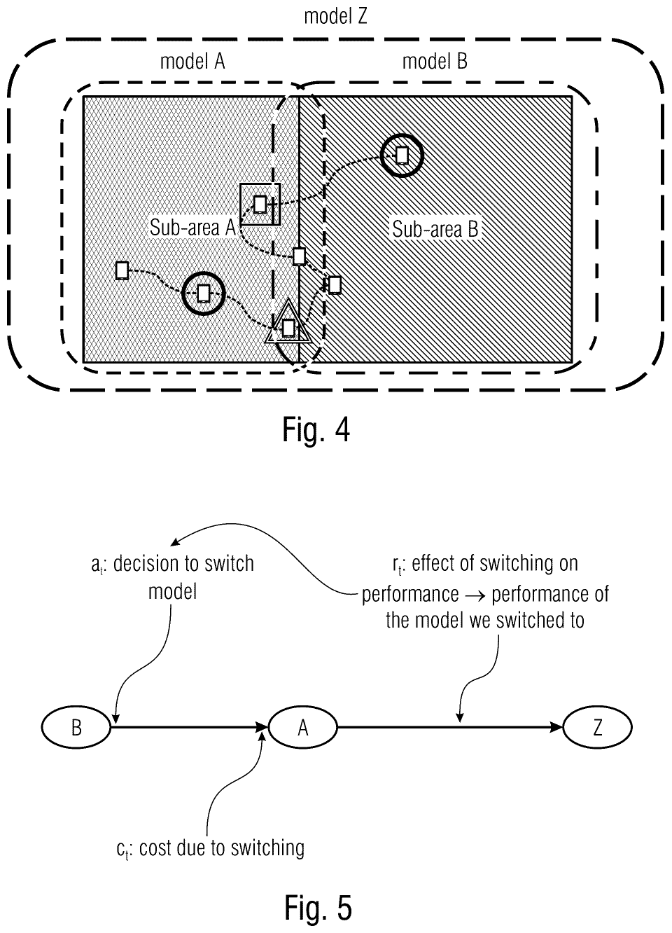

Let's assume we have the following example area shown in FIG. 4. In this example, we have the following assumptions:
1. For simplicity, we assume in this example that all models are trained and do inference at the UE.
2. Example functionalities could be:
   models for Beam Management (i.e., select the best serving beams out of X total beams without measuring all of them).
   Models for positioning (i.e., estimate the positing of the UE).
3. Training properties of available AI/ML models:
   Model A is trained with data from Sub-area A (+some data from the boundary with Sub-area B), so there is some buffer/overlap.
   Model B is trained with data from Sub-area B (+some data from the boundary with Sub-area A), so there is some buffer/overlap.
   Model Z is a general model trained with data from several sites
4. Model complexity:
   Sub-area B is more “challenging” (e.g., more obstacles, reflections, etc.) than Sub-area A. This means that that model B could need different inputs from model A (e.g., more beam measurements for beam management or activating an additional AI/ML model for LOS/NLOS classification for positioning). It also means that model B could be larger (in terms of number of parameters) compared to model A.
   Model Z is trained with data from several sub-areas in different sites. It generalizes well, as it is not specialized to a specific sub-area, but is significantly larger (in terms of number of parameters) compared to models A and B.
5. Model performance:
   Models A and B are “specialized” models so they have the best performance in their respective sub-areas.
   Model Z has lower performance but covers the entire area.
   There is a non-AIML model available, which has the worst performance compared to the available AI/ML models. This is sometimes called a Fallback model, since we can revert to this if the performance of AI/ML models degrades (e.g., we have several temporary blockages, or the environment geometry permanently changed significantly).
   If we use positioning as an example, let's assume that we have the following performance per model:
      Model A→<20 cm accuracy in sub-area A
      Model B→<20 cm accuracy in sub-area B
      Model Z→<2m accuracy in the entire area
      non-AIML model→<5m accuracy in the entire area
   In another example, equivalent KPIs for BM may, e.g., be considered.
6. Cost of model selection/activation/deactivation/switching:
   If we look at the UE trajectory, in this case, if models A and B are used, a mechanism for model switching should be in place, to ensure a high-level of performance in the entire UE trajectory.
   We can have different situations with different levels of cost:
      Example #1: Model A and Model B support the same functionality. This means that model switching happens within the same functionality with small selection/activation/deactivation/switching cost 4 same input/output/side information configuration and no coordination with the gNB needed.
      Example #2: Model A and Model B support different functionalities (e.g., different Set A/Set B for BM). This means that functionalities (configurations) also have to switch with increased selection/activation/deactivation/switching cost 4 potentially different input/output/side information configuration and mandatory coordination with the gNB needed.
      Example #3: models A and/or B are not stored at the UE device. In this case, the models need to be downloaded from the NW or using the user plane, before activated.

In this example, a proper model/functionality selection/activation/deactivation/switching mechanism should have the following properties:
Should be able to predict the performance of each available model (A, B, Z) and the Fallback in UE location.
Should be able to decide that in the UE locations indicated by the black circles, sub-model A or sub-model B would be the best choice.
Should be able to anticipate that relative model performance is likely to change, when UE is at the location indicated by the red square.
Should be able to consider the cost of model/functionality selection/activation/deactivation/switching and decide accordingly in situations where both models could be used, for example when UE is at the location indicated by the grey triangle.

FIG. 4 illustrates a model-switching scenario. Dashed lines indicate the applicability of the respective models.

According to 3GPP, in all cases, the task is to switch to a better performing model Y before the performance of the currently used model X drops below acceptable levels, so the switching has to be a timely and robust decision. The discussion in the standard attempts to achieve this by:
1. clearly defining when (under which conditions) a model is suitable to be activated/used.
2. “load” candidate inactive models that could be used based on current conditions/measurements, run them in parallel to the currently running model and evaluate if they would perform better than the active model.

Multiple models should be developed with overlapping coverage (e.g., model 1 for SNR<20 dB, model 2 for SNR>10 dB) to allow a margin for imperfect model selection/switching” to make model selection and witching mode robust.

This solution has several problems:
1. Loading inactive models in parallel and performing inference is computationally expensive for the UE.
2. Determining if inactive model(s) are better than the active model, could need getting ground truth labels for monitoring purposes.
3. If the UE is in a sub-region or a set of conditions that more than one models can be applied, there is the chance/danger that we are stuck at a constant model switching.
4. Loading inactive models that perform the same task (so they can be activated under the same applicable conditions) but have different implementations (e.g., Transformers vs CNN, smaller/larger models, etc.) or belong to different functionalities (so might need different inputs) is still challenging.

According to some embodiments:
1. Instead of loading candidate inactive models and running them in parallel, construct an estimator that for selected inactive functionalities/models it predicts the expected benefit of activating the functionality/model, taking into account the expected performance/QoS the model will bring, as well as the cost due to selection/activation/deactivation/switching to the candidate functionality/model.
2. The estimator should not only provide one-step predictions, i.e., the immediate performance/cost estimation, but should encode in the prediction the long-term performance/cost trade-off of activating a specific model, taking into account short-term requirements for model (re-) switching, based on the available model and radio environment properties.

For the estimator to “encode in the prediction the long-term performance/cost trade-off of activating a specific model, taking into account short-term requirements for model (re-) switching, based on the available model and radio environment properties,” we model the problem of optimal AI/ML model selection/activation/deactivation/switching, for example, as a Markov Decision Process (MDP). Markov Decision Process (MDP) is a framework for modeling sequential decision making problems under uncertainty.

An MDP may, e.g., be defined by the following:
A set of actions A—this is every action/decision we can make. In our case, this would be the decision to select/activate (or switch to) a specific AI/ML functionality/model or select to activate a fallback/non-AI/ML functionality/model. The expected benefit of each model (potential action) is the output of the estimator.
A set of states S—these are all the measurements available, that can provide information to the estimator to make the right decision. Simply put, the information that we are currently using model A does not suffice to predict if another model would be better. In our case, some example inputs/measurements that can be used in any combination may, e.g., be the following:
   Information on which functionality/model is active now (in case a functionality/model is active) and its properties.
   Information on the performance (or associated QoS) of the current active functionality/model (in case a functionality/model is active).
   Potential performance requirements and/or cost constraints.
   The input data (for the last X timesteps) the AI/ML model used (in case a model is already active).
   Measurements that are related to the applicable conditions of the functionality (e.g., SNR levels, UE speed, Doppler, beam codebook type, PRS identity, model pairing information for two-sided models, network synchronization error, UE/gNB RX and TX timing error, etc.).
   Information on alarms (potential indicators of performance degradation of the active AI/ML model) and/or results of monitoring metric calculations in general, from other model monitoring entities.
   Information on the amount of time the current active model has been activated.
Information on alarms (potential indicators of performance degradation of the active AI/ML model) from other model monitoring entities.
   Information on the amount of time the current active model has been activated.
   High-level features/post-processed information on the UE state. For example, UE orientation/position/velocity, predicted future UE trajectory, etc.
   Side information from the network, on the general properties of the radio environment, reported problems from other UEs, etc.
   Cell/Area/Dataset ID.
A reward function R that shows us how good or bad our decisions are—if we measure sₜ and take action aₜ, we receive a real number rₜ(sₜ, aₜ) that expresses the effect our action had. In our problem, the reward function has a performance and a cost part (these are not inputs to the estimator but are used for its training/programming):
   (Immediate) cost of or selection/activation/deactivation/switching to an AI/ML model (cₜ).
      When switching between models in the same functionality, this can be manageable since the models should have the same input/side-information requirements and no explicit signaling/coordination between the UE and the NW is needed.
      When switching between models of different functionalities, this can be significant since the models could have input/side-information requirements and explicit signaling/coordination between the UE and the NW is needed. In some cases, like in Beam Management where different functionalities can facilitate different Set A/Set B, a new set of beam measurements from the UE might be needed as inputs to the newly activated model. Note here that additional cost terms can be added (e.g., a complexity cost proportional to the size of the AI/ML model, an energy cost proportional to the energy requirements for using the model, an overhead cost If the model is not stored at the UE and needs to be downloaded, etc.).
   (Immediate) model performance (rₜ). This can be the positioning accuracy in positioning use cases, the throughput, or the best beam prediction accuracy in beam management use cases, etc. A subtle detail here is when this performance indicator is calculated: In order to know if a switch was successful or not, we have to monitor the (average) performance of the newly activated model until it is deactivated/switched. FIG. 5 illustrates when the cost/performance indicators for a decision aₜ at time t are calculated. In a variation of this (immediate) model performance indicator, the model performance could be marked as sub-par in case an immediate model switch or a fallback followed (to put it simply, if the model worked good for 5 timesteps but then its performance dropped and we needed to switch to a better model or to a fallback/non-AI/MVL solution, then the performance was in reality inadequate).
A discount factory γ∈[0, 1] that helps us determine how “far” in the future the effects of our actions reach (for example, did the activated model lead to long-term model performance? Were more model switches—possibly in sort time—needed?).
The transition model T—this is how the world evolves (laws of physics, how the radio environment will evolve in the future, how the UE will move, etc.).

FIG. 5 illustrates a calculation of a performance benefit and cost of a model activation or switching decision according to an embodiment.

In embodiments, it is assumed that a model selection/activation/deactivation/switching strategy (also called policy π) is available. This will take as input the states/measurements sₜ and select a model (take an action) aₜ=π(sₜ).

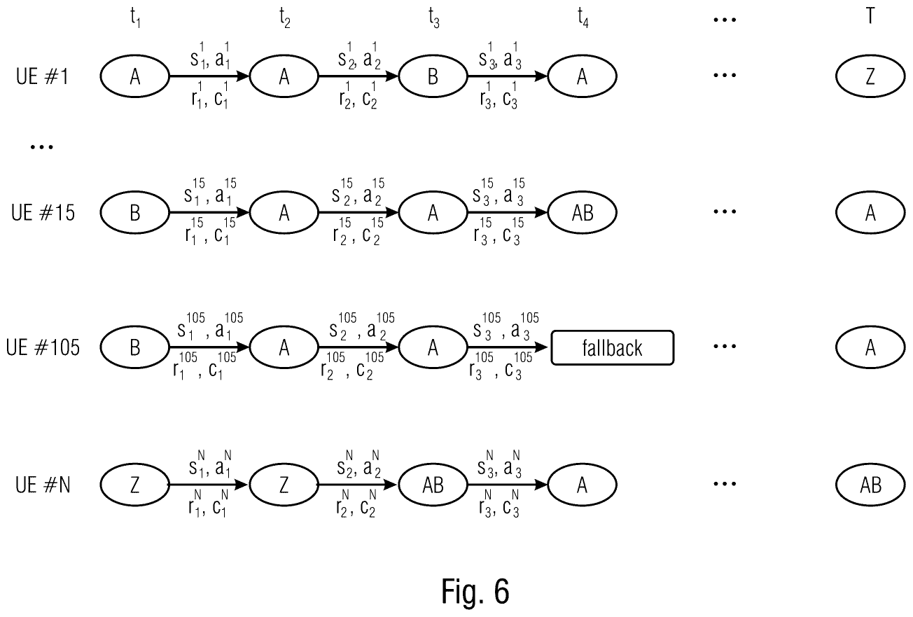

The solution has two estimators (written as Qᵣ(sₜ, aₜ) and Q_{c}(sₜ, aₜ) for the performance and cost respectively). These are functions that takes as input the states/measurements sₜ and predict the long-term benefit (Qᵣ) and the long-term selection/activation/deactivation/switching cost (Q_{c}) of selecting/activating/deactivating/switching to a specific model now (aₜ) and following the selection/activation/deactivation/switching strategy Ti from that point onwards. For example, consider the data collected from different UEs depicted in FIG. 6. Here, a sequence of states, actions and performance/cost KPIs are gathered. The estimators Qᵣ and Q_{c} are trained in a way that encodes that selecting a model at time t=1 does not only affect the states/performance/cost at time t=3, but could have a long-term effect (e.g., a switching to a model of a different functionality was needed eventually, so maybe a better decision is to start with a model from that functionality). This can be achieved, by e.g., training the Q functions using future performance/cost values from the entire UE trajectory/experience (potentially weighted to give higher importance/confidence to immediate outcomes).

Typical algorithms here could be Monte Carlo estimation or TD learning.

FIG. 6 illustrates data collected from model selection/activation/deactivation/switching from several UEs in the same area at different times (e.g., days, time of day, etc.) according to embodiments.

The last part of the solution is how the proper model is selected. Here there are several options:
The model with the best performance is utilized, regardless of the associated cost.
A performance requirement \hat{r}ₜ is provided. The estimator Qᵣ is queried and a list of candidate models that would be expected to fulfill the performance constraint is compiled. The final model to be activated is the one on this list with the smallest expected cost according to Q_{c}.
A maximum acceptable cost ĉₜ is provided. The estimator Q_{c} is queried and a list of candidate models that would be expected to fulfill the cost constraint is compiled. The final model to be activated is the one on this list with the highest expected performance according to Qᵣ.

In the following, a particular example according to an embodiment is presented.

As an illustrate example, let's consider the 2-sub-areas of FIG. 4. Also, let's assume that we map the model positioning accuracy from [0.0m, 10.0m] to [1, 0], meaning that a perfect model will have a performance equal to 1 and a model that has positioning accuracy worse than 10m, will have performance equal to zero. Also, let's assume the following initial estimates on the model performance on a direct positioning task:
Model A→<20 cm accuracy in sub-area A. In scaled performance in [0, 1], let's assume that this performance is r^{A}=0.98.
Model B→<20 cm accuracy in sub-area B. In scaled performance in [0, 1], let's assume that this performance is r^{B}=0.98.
Model Z→<2m accuracy in the entire area. In scaled performance in [0, 1], let's assume that this performance is r^{Z}=0.8.
non-AIML model→<5m accuracy in the entire area. In scaled performance in [0, 1], let's assume that this performance is r^{Fallback}=0.5.

Moreover, let's assume that we have collected data from several UEs in the form shown in FIG. 6. As a scenario, assume that Model B does not perform as expected and instead of positioning accuracy of <20 cm it has an accuracy level of <80 cm. In scaled performance in [0,1], this performance is r^{B}=0.92. Based on the data and the Qᵣ and Q_{c} estimator construction/training, we have the following:
Qᵣ(s_{*},Z)=0.8. Model Z has the same performance everywhere.
Qᵣ(s_{*},Fallback)=0.5. Fallback (non-AI/ML) has the same performance everywhere.
Q_{c}(s_{*},Z)=0.0. Model Z has no selection/activation/deactivation/switching cost as it is applicable in the entire area.
Q_{c}(s_{*},Fallback)=0.0. Fallback (non-AI/ML) has no selection/activation/deactivation/switching cost as it is applicable in the entire area.
Qᵣ(s_{A},A)=0.98. Using model A in the area it is valid (states s_{A} indicate model A was trained with these data), has an expected performance of 0.98.
Qᵣ(s_{B},A)=0.0. Using model A in the area it is not valid valid (states s_{B} indicate model B was trained with these data), has an expected performance of 0.0. There is a chance that it performs better than 0.0, but we don't have data from UEs to know this (we have not used model A in area B during training/deployment)
Qᵣ(s_{B},B)=0.92. Using model B in the area it is valid (states s_{B} indicate model B was trained with these data), has an expected performance of 0.92 (which is what the new data after deployment indicated and not the initial estimate).
Qᵣ(s_{A},B)=0.0. Using model B in the area it is not valid valid (states s_{A} indicate model A was trained with these data), has an expected performance of 0.0. There is a chance that it performs better than 0.0, but we don't have data from UEs to know this (we have not used model B in area A during training/deployment)
Q_{c}(s_{LA},A)=Q_{c}(s_{RB},B)=0.0. Assume that when the UE is in the left side of sub-area A (s_{LA}, marked with a circle in FIG. 4) or in the right side of sub-area B (s_{LB}, marked with a circle in FIG. 4) the (normalized) cost of selection/activation/deactivation/switching is 0.0, since there is no switching recorded in the data. Also, model A has expected performance 0.0 in sub-area B and vice-versa, so there is no point for model selection/activation/deactivation/switching there.
Q_{c}(s_{AB},A)=Q_{c}(s_{AB},B)=0.7. Assume that when the UE is in the A, B overlapping area (s_{AB}, marked with a triangle in FIG. 4), the expected selection/activation/deactivation/switching cost (irrespective of which model is currently active) is high (0.7), since we expect (based on the available data) that frequent switching is needed to maintain high performance.

Now let's consider two scenarios: scenario #1, where selection/activation/deactivation/switching costs are acceptable and we need the best possible positioning accuracy and scenario #2, where selection/activation/deactivation/switching costs more than ĉₜ=0.5 is unacceptable.

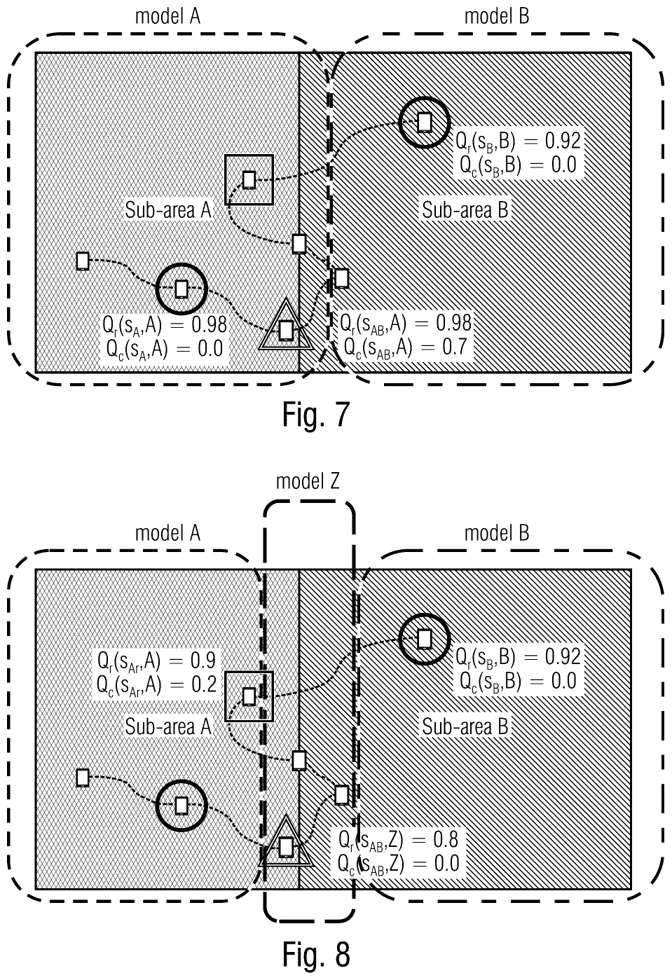

Now, a first scenario #1 (best performance, see FIG. 7) according to an embodiment is described.
In the left of sub-area A, model A is used, since it is the best performing model and no switching is expected.
In the right of sub-area B, model B is used, since it is the best performing model, and no switching is expected.
In the overlapping sub-area, model A is used. Both models (A and B) have the same expected cost (Q_{c}(s_{AB},A)=Q_{c}(s_{AB},B)=0.7), but model A has higher expected performance.

FIG. 7 illustrates the first scenario (#1), where model A is activated in the overlapping AB area according to an embodiment. Solid lines indicate the model applied in each UE location, according to the performance/cost trade-off based on Qᵣ and Q_{c} respectively

Now, a second scenario #2 (avoid high cost, see FIG. 8) according to another embodiment is described.
In the left of sub-area A, model A is used, since it is the best performing model and no switching is expected.
In the right of sub-area B, model B is used, since it is the best performing model, and no switching is expected.
In the overlapping sub-area, model Z is used. Both models (A and B) have the same expected cost (Q_{c}(s_{AB},A)=Q_{c}(s_{AB},B)=0.7), which is higher than the maximum acceptable cost (ĉₜ=0.5). The next best performing model is model Z, which has zero cost, hence is the one activated in the overlapping area.
Note that when the UE is close to the overlapping area where switching to model Z is possible (UE location indicated by the square in sub-area A), the expected selection/activation/deactivation/switching cost is not zero (Q_{c}(s_{A′},A)=0.2), but it is not higher than 0.5 either, because the model to be activated is model Z, which does not require switching (it covers the entire area).
Similarly, the expected performance is not the performance of model A, but lower (Qᵣ(s_{A}′,A)=0.9). This is because a switch to model Z is possible, and model Z has lower performance than model A, hence the average expected performance is lower.

FIG. 8 illustrates the second scenario (#2) according to an embodiment, where model Z is activated in the overlapping AB area. Solid lines indicate the model applied in each UE location, according to the performance/cost trade-off based on Qᵣ and Q_{c} respectively.

In the following, particular, supported AI/ML Use Cases according to embodiments are presented.

At first, an AI/ML positioning use case according to an embodiment is described.

For 5G positioning, two AI/ML approaches are considered: direct and assisted positioning. Model inference can be performed at the UE or at the Network. In direct AI/ML positioning, the UE location is directly inferred by the AI/ML model using channel observation data collected from signal measurements, such as signal power, channel impulse response (CIR), and time-of-arrival (ToA) and angle-of-arrival estimates (AoA). If the device has multiple antennas, measurements for each antenna or beam can be provided. Also, side information, like UE reporting its velocity based on internal sensors, are also supported.

In AI/ML assisted positioning, the AI/ML model preprocesses the measurements, and the position is calculated by other algorithms. The AI/ML model provides new or enhanced measurements, such as LOS/NLOS identification, AoA estimation, ToA estimation, measurement quality/reliability information, correction values, and measurement classification. For example, the model may identify specular or diffuse reflections in the measurements.

An example of a functionality switch from sub-area A to sub-area B and vice-versa may, e.g., be implemented as follows:
Functionality #1 for sub-area A supports CIR as AI/ML model inputs. When switching to sub-area B, which is more challenging, the AI/ML model also utilizes velocity information from the UE, along with the CIR, i.e., another functionality needs to be activated and coordinated between the UE and the NW.

Now, AI/MWL Beam Management use case according to an embodiment is described.

For AI/ML-based beam management, in case1 spatial-domain DL beam prediction for Set A of beams based on measurement results of Set B of beams. In case2, temporal DL beam prediction for Set A of beams based on the historic measurement results of Set B of beams. The AI/ML input for both cases can be RSRP or a CIR measurement based on Set B or RSRP measurement based on Set B and assistance information (Tx and/or Rx beam shape information (e.g., Tx and/or Rx beam pattern, Tx and/or Rx beam boresight direction (azimuth and elevation), 3 dB beamwidth, etc.), expected Tx and/or Rx beam for the prediction (e.g., expected Tx and/or Rx angle, Tx and/or Rx beam ID for the prediction), UE position information, UE direction information, Tx beam usage information, ULE orientation information, etc.

An example of a functionality switch from sub-area A to sub-area B (assuming a codebook of 64 beams) and vice-versa may, e.g., be implemented as follows:
Functionality #1 for sub-area A supports a set B of 10 beams (meaning measuring the RSRP of 10 beams before the prediction) and a set A of 54 beams. The model for sub-area A, for functionality #1, needs to predict the single best beam out of the 54 beams that are not measured. When switching to sub-area B, which is more challenging, the AI/ML model needs measuring more beams in set B (e.g., 16 beams) and predicting (and measuring) the 5 most probable best beams out of the remaining 48 beams of Set A. This different configuration corresponds to a different functionality that functionality needs to be activated and coordinated between the UE and the NW.

Now, an AI/ML CSI compression use case according to an embodiment is described.

AI/ML for CSI compression is based on two sided model approach. In a two sided model, a paired AI/ML Model(s) over which joint inference across the UE and the network is performed, i.e., the first part of inference is performed by the UE and then the remaining part is performed by network, or vice versa.

CSI compression using machine learning (ML) involves training a model to learn and compress channel state information (CSI) from raw channel or precoding matrices. The compressed CSI is transmitted from the UE to the NW, where it is decompressed and used for beamforming and other functions. Different compression models can be used depending on the available payload size and network configuration. The alignment of input-CSI-NW and output-CSI-UE options needs to be studied to ensure proper model training and performance AI/ML energy saving. In CSI compression using two-sided model use case, the NW configure the max payload size. UE selects the rank and CSI generation model within the max payload size constraint configured by the network. In an alternating option, the NW configures a list of model IDs and max payload size, and UE selects rank and CSI generation model from the configured list and within the max payload size constraint configured by the network. In a third option, the NW configures the model ID to be used by the UE, UE will use the corresponding CSI generation model configured by the NW.

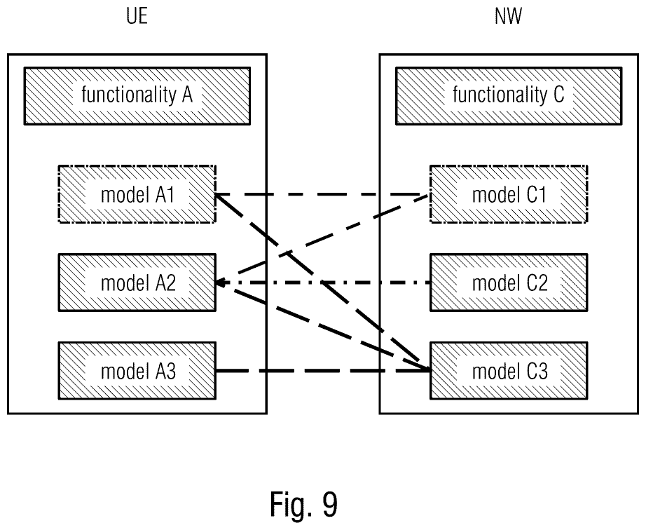

FIG. 9 illustrates a model switching operation in a two-sided operation according to an embodiment.

In two-sided models according to FIG. 9, Model A1 is active on the UE side and Model C1 is active on the NW side. The decision for UE to switch, activate or select a model depends on the NW functionality.

In one aspect, the UE may be allowed to switch based on the evaluation to model A2 since the functionality of Model C1 is applicable for both A1 and A2. The NW and UE exchange functionalities supported by the UE and NW. The UE may be configured by the NW with rules to facilitate model switching. In an alternative, the UE may be allowed to freely activate/switch models conditioned the output and NW functionality is not affected (A1 or A2).

In the same example, if the UE predicts that a model A3 activation is beneficial, the UE requests from the NW activation for Model A3. The UE can also provide the expected benefit information to the NW.

In different aspect, the estimator according to the solution proposed can be optimally aligned between the NW and UE. In this case. The expected benefit is determined by the NW and the UE by actions or/and states or/and rewards.

Now, an estimator output according to an embodiment is described.

It should be noted here that in all the supported use cases, the estimator output is the same: an estimate of the expected AI/ML model performance (Qᵣ) and/or an estimate of the expected selection/activation/deactivation/switching cost (Q_{c}). Note that we can also have confidence intervals in these estimates (so an indication on how certain/robust the estimator's prediction is).

In the following, capabilities and NW signaling according to embodiments are described.

In one aspect, the apparatus (UE or BS) provides the NW with information on the number supported functionalities by the UE. The UE provides the Network with the number of supported models within the functionalities. Wherein the apparatus is to evaluate at least one functionality or model for the purpose of selection, activation, deactivation or switching. In a related aspect, the apparatus being a UE is to receive an indication from the network on the preferable or applicable models or/and functionalities. Wherein the UE will select a model for evaluation, based on this indication will evaluate the expected performance or a parameter indicative of the selected performance.

In a second aspect, the UE can receive from the NW a configuration message. The configuration message includes information to enable the UE to evaluate the performance benefit from the one or more model. The information can comprise an information on the QoS, or/and QoS or/and configuration to enable the UE to set the optimum states, actions and/or reward.

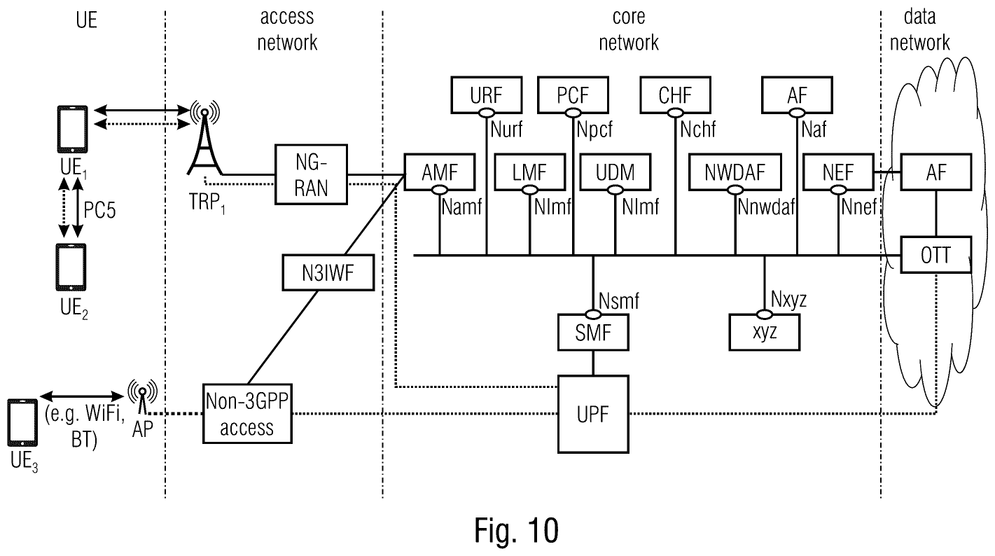

FIG. 10 illustrates an example representation of a 3GPP network depicting representative functional blocks.

In particular, FIG. 10 depicts the components of the 3GPP wireless communication system (or 5G System (5GS)). The system consists of user equipment (UE), access network (AN), core network (CN), and data network (DN). A UE registers itself with the AMF via either the NG-RAN node (such as gNB) using 3GPP defined radio access technology, such as NR or via a non-3GPP access method (such as WiFi) via the non-3GPP interworking function (N3IWF).

The core network contains one or more functions that can interact with each other using the so-called service based architecture using interfaces. As an example, the AMF can send message to LMF via the Nlmf interface and the LMF can send message to AMF using the Namf interface.

In the following, a brief description of the network entities/functions is provided to give a simplified view of the working principle of the core network. In the core network, the AMF (access and mobility function) is the network function through which control plane signaling from the core network are sent to the UE. A UE registers in the network with the AMF. It manages the mobility of user devices and handles access authentication and authorization in the 5G core network. The LMF (location management function) is responsible for determining the location of the UE by interacting with one or more network functions and/or access network nodes and/or the UE and providing the location to the location service client, which may be another application function (AF), an AMF, UE, entity in the access network or in the external network. The network exposure function (NEF) exposes the services, capability and/or information to external applications and third-party in a secure and controlled way. There may be an application function in the data network, which may be able to access the information from the 5GS via NEF or directly using the service-based architecture. Network repository function (NRF) provides a centralized repository for network function information in the 5G core network, facilitating the discovery and access of available network functions and their capabilities. Charging function (CHF) manages the charging and billing aspects of user services in the 5G core network, including data usage, service subscriptions, and payment authorization. Policy control function (PCF), controls and manages policy-related decisions and enforcement for Quality of Service (QoS), network resources, and user access in the 5G core network. Unified Data Management (UDM), stores and manages user-related data such as subscriber profiles and authentication credentials in the 5G core network. Unified Data Repository (UDR), serves as a central storage for user-related data in the 5G core network, including subscription and session information. Network data analytics function (NWDAF) collects and analyzes network data, providing insights for network optimization, Quality of Service (QoS) improvements, and resource allocation in the 5G core network. Authentication Server Function (AUSF), handles authentication and security-related functions, including generating authentication vectors and verifying user identities, in the 5G core network. There are, of course, further application functions in the network beyond what is discussed above and the functionality described above is to only give a broad picture of what an application function may do but not to limit the functionality of an application function.

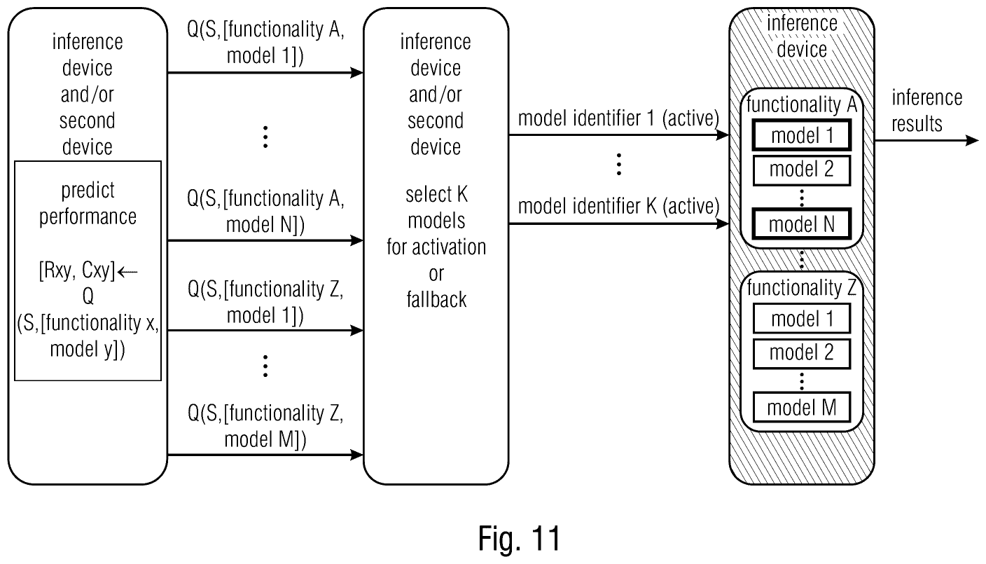

FIG. 11 illustrates transmissions of a number of inference devices in a wireless communications system according to an embodiment.

The OTT server depicted in FIG. 10 can be an entity managed by the network or it may be a third party server (e.g. from a vendor). The OTT may acquire information from the 5GS for training the estimator based on performance of the inference device and/or output of the estimator and/or ground truth and/or additional information. It may acquire the information using network exposure interface. For example, a specific UE vendor ‘A’ may be running inference models at the UE which are loaded to the UE via application layer (5G user plane data via 3GPP access network, non-3GPP access network or simply via external data connection (e.g. standalone WiFi). The vendor may be interested in one or more features for training the estimator (for example: UE location computed at the network, or RSRP of the received signal, or block error rate (BLER). The vendor may subscribe to certain information (e.g. ground truth, such as UE location, RSRP, BLER . . . etc) via the NEF of the network. The received data may be provided a unique mechanism to relate data from different sources (e.g. time stamped), so that the OTT can align the information received from the UE with the information received from the network to train data for the model/functionality or train the estimator to predict the performance of the model.

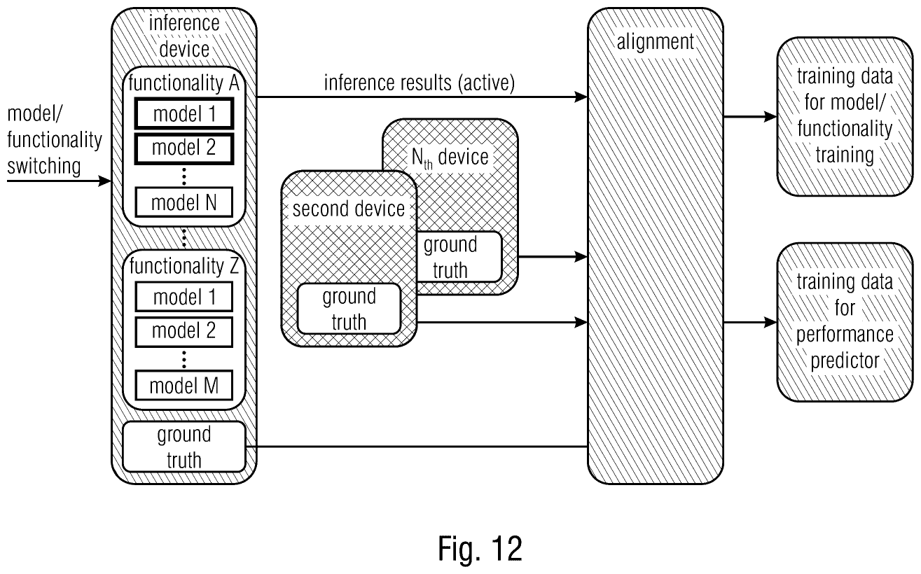

FIG. 12 illustrates transmission from an inference device in a wireless communication system according to an embodiment.

A first case according to an embodiment relates to a case, where the inference model is located at the UE, and the estimator is also located at the UE: A vendor or a network may have several models available for a particular functionality.

However, only a subset of the models may have been stored by the UE. The number of models stored by the UE (K) may be subject to the capability of UE. The UE may be provided an estimator model, which estimates the performance of L models, where L>=K. As an example, the UE may have a generic model and k specific models stored at the UE. The generic model may provide results for coarse positioning within a city, and the specific models may provide finer resolution positioning. The estimator may predict the best performing model which may not be stored in the UE. The UE may then need to make the request to the network and/or OTT server or other UEs in vicinity (e.g. via Sidelink) to download and activate the model.

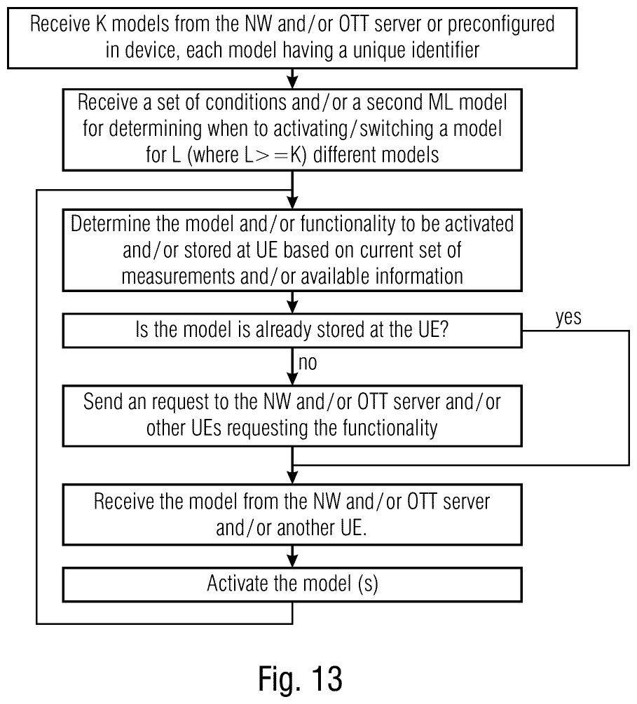

FIG. 13 illustrates a mechanism of combining labelled data from an inference data with ground truth obtained from one or more sources to obtain labelled data for training a model and/or a functionality and/or a performance indicator according to an embodiment.

In an example, the model may be stored at the OTT server and/or at the network entity. Delivery of the model may be subject to authorization and subscription of entities. Therefore, when the UE makes the request to the network, the network entity (e.g. LMF) may need to to interact with UDM/AUSF to check whether the requested model is authorized and/or within the subscription of the UE. Furthermore, the network entity may need to interact with other network functions such as URF and/or NWDAF and/or UDM and/or UDR. If the model exists at the network and the UE has subscription and/or authorization to use the model, then the network function provides the model to the UE.

Otherwise, the network function may signal a fallback solution to the UE and/or indicate a fallback model and/or provide a fallback model.

The AI/ML model may, e.g., be trained at the core network (for example, in the NWDAF or another application function) and stored at the core network at an entity or application function, such as the UDR). Alternatively, the model may, e.g., be trained at an entity outside the core network, for example, at a computing system outside the 5G core network and may, e.g., be delivered to the 5G core network. One way to do so would be that an application function in the 5G core network allows the external entity which has a trained model stored in it to publish to the application function inside the core network, for example, using the NEF interface. Alternatively, the AF inside the CN may, e.g., subscribe to the entity outside the core network (for example, a server in the data network) and obtain the model by interacting with the server in the data network. As a further alternative, the model can, for example, be transferred using operation and maintenance interfaces.

A network function may, e.g., interact with the UDM or a second network function, e.g., to determine the authorization and/or subscription to request certain data from the UE and/or to provide data collected from the UE to a third network function or a client or server. For example, the UE may, e.g., have privacy profiles stored at the UE, or one or more network entities may have stored privacy profiles and/or authorization stored. The information may, e.g., be provided to entities outside the 5G core network and/or outside the network function that has obtained the information, subject to authorization to do so. As an example, the measurement obtained by a network entity associated with a transmission from a UE and/or the measurement or information reported by a UE may be transferred to an external client (e.g., a server in the data network) subject to authorization. For example, if the UE has denied the location related information being shared to an external client, then the external client cannot obtain the training data from the said UE. The privacy profile may be stored in an AF (such as AMF or UDM or UDR or AUSF).

The delivery of model may, e.g., be subject to subscription and/or authorization to the UE.

A second case according to another embodiment relates to a case, where the inference model is located at least at the UE, and where the estimator is located at the network (e.g. LMF).

Similar to the case above, the network may have a better performing model for the given functionality, which may not be stored at the UE. The estimator function at the network side may estimate that an another model may be more suitable for the UE, given the current conditions or that the network may predict that another model may be needed in near future.

The network may determine that it may be advantageous to store the model in advance at the UE. For example, if we assume a vehicle driving along the highway or an AGV in an industry floor, the network may be analyzing the location data to predict the next location and the model for such location.

The network entity may determine that a new model may need to be loaded at the UE ahead of time when the new model would be better performing model.

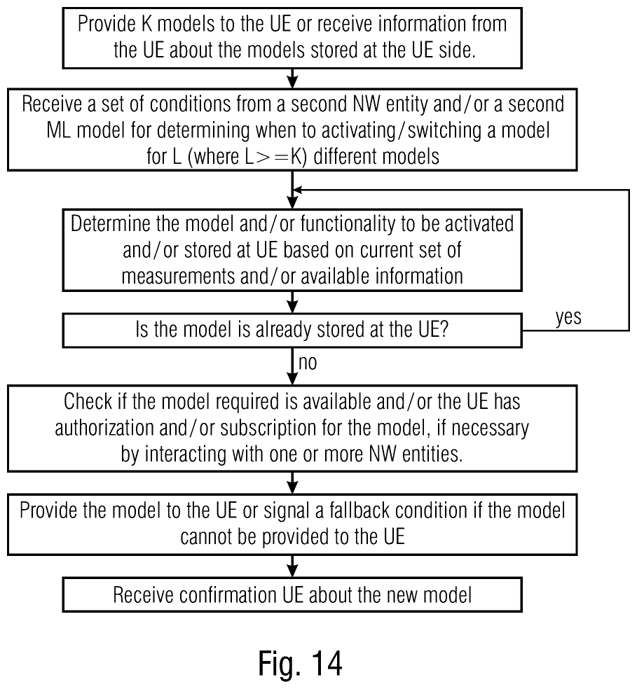

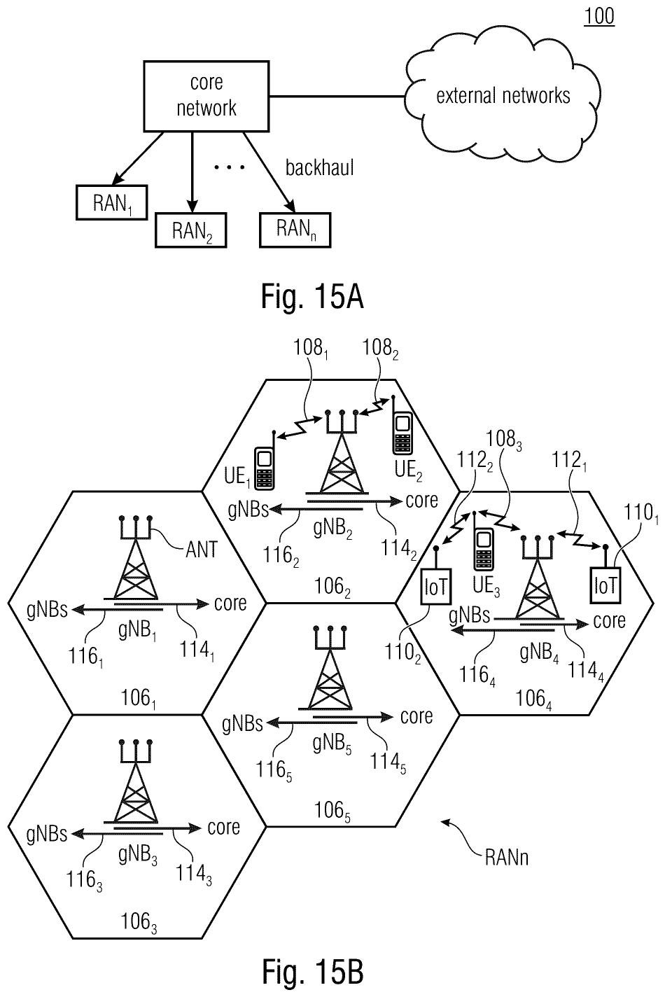

FIG. 14 illustrates a flow chart for providing one or more AI/ML models from the network to a user equipment according to another embodiment.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

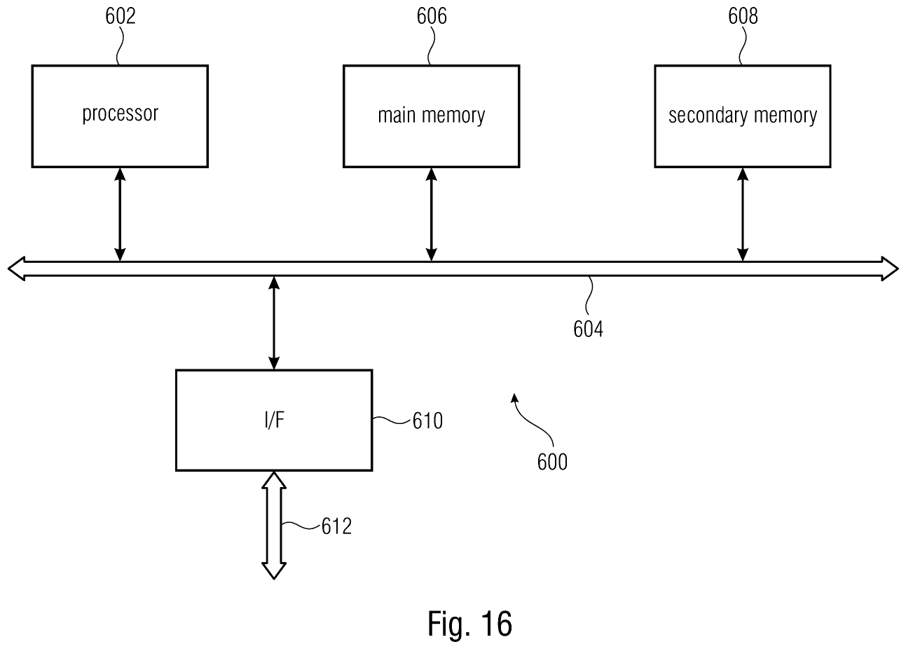

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 16 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

ABBREVIATIONS

| Abbreviation | Definition |
|---|---|
| 3GPP | third generation partnership project |
| 5GC | 5G core network |
| BS | base station |
| CSI-RS | channel state information reference signal |
| DMRS | demodulation reference signal |
| DOA | direction of arrival |
| E-CID | enhanced cell ID |
| eNB | evolved node b |
| E-SMLC | evolved serving mobile location center. |
| E-UTRA | evolved UMTS terrestrial radio access |
| gNB | next generation node-b |
| GPS | Global Positioning System |
| LMF | location management function |
| LMU | location measurement unit |
| LPP | LTE positioning protocol |
| LTE | Long-term evolution |
| NG | next generation |
| ng-eNB | next generation eNB |
| NG-RAN | either a gNB or an ng-eNB |
| NR | new radio |
| NRPPa | new radio positioning protocol a |
| OTDOA | observe time difference of arrival |
| PRS | positioning reference signal |
| PTRS | phase tracking reference signal |
| QCL | quasi colocation |
| RAN | radio access network |
| RP | reception point |
| RSTD | reference signal time difference |
| RTOA | relative time of arrival |
| RTT | round trip time |
| SA | Standalone |
| SRS | sounding reference signal |
| TDM | Time Domain Multiplexing |
| TOF | time of flight |
| TRP | transmission reception point |
| RS | reference signal |
| QCL | quasi co-located |
| AoA | Angle of Arrival |
| AoD | Angle of Departure |
| PAS | Power Angular Spectrum |
| NR | New Radio |
| gNB | next generation node-b |
| GPS | Global Positioning System |
| LMF | location management function |
| LMU | location measurement unit |
| LPP | LTE positioning protocol |
| LTE | Long-term evolution |
| NG | next generation |
| ng-eNB | next generation eNB |
| NG-RAN | either a gNB or an ng-eNB |
| NR | new radio |
| CA | carrier aggregation |
| CAM | Cooperative Awareness Message |
| DAS | distributed antenna systems |
| DL | Downlink |
| FL | Frequency layer |
| FC | Frequency component. This is either a BWP of a |
| | wideband carrier or |
| GNSS | Global navigation satellite system |
| OOC | Out-Of-Coverage |
| PSFCH | Physical Sidelink Feedback Channel |
| P-UE | Pedestrian UE: should not be limited to pedestrians, |
| | but represents any UE |
| RS | Reference signal |
| RE | resource elements |
| SINR | Signal to interference and noise ratio |
| SL | Sidelink |
| SPRS, SP- | Sidelink positioning reference signals |
| V2X | Vehicle to anything |
| VRU | Vulnerable road user |
| V-UE | Vehicular UE |
| BWP | Bandwidth Part |
| TEG | Timing Error Group |
| ZC | Zadoff-Chu sequence |
| UE | User equipment |
| UL | Uplink |
| Uu (interface) | Interface between UE |
| ToA | Time of Arrival |
| TDOA | Time Difference of Arrival |
| LOS | Line of sight |
| PRU | Positioning reference unit |
| ToF | Time of flight |

1. An apparatus of a wireless communication system,
wherein the apparatus is configured to determine a metric for an AI/ML model of one or more inactive AI/ML models and/or for a functionality thereof, wherein the one or more inactive AI/ML models are suitable for supporting a task of a user equipment and/or of a network entity of the wireless communication system, the apparatus being the user equipment or being different from the user equipment; wherein the apparatus is configured to determine the metric for the AI/ML model and/or for the functionality thereof, such that the metric takes a benefit of employing the AI/ML model and/or the functionality thereof into account, and such that the metric takes an activation effort for activating the AI/ML model and/or the functionality thereof into account,
wherein the apparatus is configured to determine, depending on the metric for the AI/ML model and/or for the functionality thereof, whether or not to activate the AI/ML model and/or the functionality thereof.

2. An apparatus according to claim 1,
wherein the apparatus is configured to activate the AI/MVL model, if the apparatus has determined that the AI/ML model shall be activated.

3. An apparatus according to claim 2,
wherein the apparatus is the user equipment; and the apparatus is configured to employ the AI/ML model to perform the task, if the apparatus has determined that the AI/ML model shall be activated.

4. An apparatus according to claim 1,
wherein the apparatus is different from the user equipment; and the apparatus is configured to transmit information to the user equipment to activate the AI/MVL model, if the apparatus has determined that the AI/MVL model shall be activated; or
wherein the apparatus is configured to transmit information to another apparatus of the wireless communication system to activate the AI/ML model, if the apparatus has determined that the AI/ML model shall be activated.

5. An apparatus according to claim 1,
wherein a functionality comprises a specific configuration, input, or output of an AI/ML model within the apparatus.

6. An apparatus according to claim 1,
wherein the apparatus is configured to determine a metric for an AI/ML model between multiple models thereof within a same functionality, wherein the AI/ML models within the same functionality share a common configuration, input, and output,
wherein the apparatus is configured to evaluate the benefits of employing the AI/ML models within the same functionality and the activation effort needed for each model,
wherein, depending on the determined metric, the apparatus is configured to decide whether to activate or deactivate AI/ML models within the same functionality, depending on an overall benefit and effort involved.

7. An apparatus according to claim 1,
wherein the apparatus is configured to determine a metric for a set of interconnected AI/ML models within a same functionality, wherein the interconnected models collaborate to perform a specific task,
wherein the apparatus is configured to analyse benefits of employing the interconnected AI/ML models and the activation effort needed for each individual model;
wherein, depending on the metric, the apparatus is configured to decide whether to activate or to deactivate the set of interconnected AI/ML models within the same functionality depending on a collective benefit and effort involved to utilize the interconnected AI/ML models.

8. An apparatus according to claim 1,
wherein the apparatus is configured to determine the metric for the AI/ML model and/or a functionality thereof within a current functionality, wherein the current functionality does not comprise an AI/ML feature-enabled functionality,
wherein the apparatus is configured to evaluate benefits of employing the AI/ML models and/or functionalities within the current functionality and an activation effort needed for each model and/or functionality,
wherein the apparatus is configured to determine a metric for an AI/ML model and/or a functionality thereof within a target functionality, wherein the target functionality comprises at least one AI/ML feature-enabled functionality,
wherein the apparatus is configured to evaluate the benefits of employing the AI/ML models and/or functionalities within the target functionality and the activation effort needed for each model and/or functionality; and is configured to decide whether to activate the target functionality depending on the determined metrics and evaluated benefits and activation efforts, and an overall improvement and effort involved in activating the AI/ML feature-enabled functionality.

9. An apparatus according to claim 1,
wherein the apparatus is configured to determine a metric for an AI/ML model and/or a functionality thereof within a current functionality, wherein the current functionality comprises an AI/ML feature-enabled functionality.

10. An apparatus according to claim 1,
wherein the apparatus is configured to determine the metric for the AI/ML model and/or for the functionality thereof, such that the metric takes a benefit and/or a cost of deactivating a presently employed AI/ML model and/or a presently employed functionality thereof into account.

11. An apparatus according to claim 1,
wherein the apparatus is configured to determine the metric for the AI/ML model and/or for the functionality thereof, such that the metric takes a benefit and/or a cost of switching from a presently employed AI/ML model and/or a presently employed functionality thereof to said AI/ML model and/or to said functionality thereof into account.

12. An apparatus according to claim 1,
wherein the apparatus is configured to determine, depending on the metric for the AI/ML model and/or for the functionality thereof, if the AI/ML model and/or the functionality thereof is to be activated or if a non-AI/ML (e.g., legacy) functionality shall be employed, e.g., as a fallback.

13. An apparatus according to claim 1,
wherein the activation effort for activating the AI/ML model and/or the functionality thereof comprises one or more of the following:
a computational cost, e.g. number of processing cycles, number of multiplications, etc.,
a signaling cost, e.g. data volume of signaling messages to be exchanged, e.g., between the user equipment and a unit of the wireless communication system,
an activation time for activating the model, etc.,
an increase of a latency,
a monitoring cost,
a combination thereof.

14. An apparatus according to claim 13,
wherein the activation effort for activating the AI/ML model and/or the functionality thereof comprises the monitoring cost, wherein the monitoring cost depends on an availability of PRUs for ground truth labels in positioning and/or depends on how frequent measurements of all the beams in the codebook in beam management are conducted.

15. An apparatus according to claim 1,
wherein the apparatus is configured to determine the metric for the AI/ML model and/or for the functionality thereof depending on at least one of the following:
information on which functionality/model is active now and its properties,
information on the performance or associated QoS of the current active functionality/model,
information on a cell ID, and/or an area ID, and/or a dataset ID,
potential performance requirements and/or cost constraints,
input data of the AI/ML model which is currently employed,
measurements that are related to the applicable conditions of the functionality, e.g., SNR levels, UE speed, Doppler, beam codebook type, PRS identity, model pairing information for two-sided models, and/or, e.g., a network synchronization error, and/or, e.g., a UE/gNB RX and TX timing error,
information on alarms from other model monitoring entities, and/or results of monitoring metric calculations in general from other model monitoring entities,
information on the amount of time the current active model has been activated,
high-level features/post-processed information on the UE state, for example, UE orientation/position/velocity, predicted future UE trajectory,
side information from the network, on the general properties of the radio environment, reported problems from other UEs.

16. An apparatus according to claim 1,
wherein the one or more AI/ML models comprise two or more AI/ML models.

17. An apparatus according to claim 16,
wherein the apparatus is the user equipment,
wherein the apparatus is configured to select and/or to activate one of the two or more AI/ML models and/or to switch from one of the two or more AI/ML models to another one of the two or more AI/ML models depending on which of at least two AI/ML models is activated at a network unit of the wireless communication system.

18. An apparatus according to claim 16,
wherein the apparatus is the user equipment,
wherein the apparatus is configured to receive information on rules from a network unit of the wireless communication system, wherein the information relates to select and/or to activate one of the two or more AI/ML models and/or to switch from one of the two or more AI/ML models to another one of the two or more AI/ML models.

19. An apparatus according to claim 16,
wherein the apparatus is the user equipment,
wherein the apparatus is configured to request allowance from a network unit of the wireless communication system to select and/or to activate one of the two or more AI/ML models and/or to switch from one of the two or more AI/ML models to another one of the two or more AI/ML models, and
wherein the apparatus is configured, when receiving the allowance from the network unit to select and/or to activate said one of the two or more AI/ML models and/or to switch from one of the two or more AI/ML models to said other one of the two or more AI/ML models.

20. An apparatus according to claim 16,
wherein the apparatus is the user equipment,
wherein the apparatus is configured to select and/or to activate one of the two or more AI/ML models and/or to switch from one of the two or more AI/ML models to another one of the two or more AI/ML models depending on selection information received from a network unit of the wireless communication system.

21. An apparatus according to claim 16,
wherein the apparatus is configured to determine the performances of one or more AI/ML models for supporting the task of the user equipment and/or of the network entity depending on a current position of the user equipment.

22. An apparatus according to claim 21,
wherein each of the two or more AI/MHL models is applicable for a geographical region, and
wherein, if the current position of the user equipment is located in a geographical region, where two AI/ML models of the two or more AI/ML models are applicable, the apparatus is configured to determine, if a first one or if a second one of the two AI/ML models is to be activated by determining a metric for each of the two AI/ML models,
wherein for each AI/ML model of the two AI/ML models, the metric of the AI/ML model takes a benefit of employing the AI/ML model and/or the functionality thereof into account, and wherein the metric takes an activation effort for activating the AI/ML model and/or the functionality thereof into account.

23. An apparatus according to claim 22,
wherein the apparatus is the user equipment, and
wherein, the apparatus is configured to determine the metric for each of the two AI/ML models, if the apparatus has determined that it is located in a geographical region, where the two AI/ML models are applicable.

24. An apparatus according to claim 22,
wherein the apparatus is different from the user equipment, and
wherein the apparatus is configured to receive information from the user equipment that the user equipment is located in a geographical region where the two AI/ML models are applicable, and
wherein the apparatus is configured to determine the metric for each of the two AI/ML models in response to receiving the information.

25. An apparatus according to claim 16,
wherein the apparatus is configured to determine the metric for each AI/ML model of the two or more AI/ML models and/or for a functionality thereof depending on a characteristic of a current environment of the user equipment.

26. An apparatus according to claim 16,
wherein the apparatus is configured to determine the metric for each AI/ML model of the two or more AI/ML models and/or for a functionality thereof depending on a characteristic of the user equipment and/or depending on a characteristic of the network entity.

27. An apparatus according to claim 26,
wherein the apparatus is configured to determine the metric for each AI/ML model of the two or more AI/ML models and/or for a functionality thereof depending on a state of a battery power of a user equipment and/or depending on an active battery power saving mode.

28. An apparatus according to claim 16,
wherein the apparatus is configured to determine the metric for each AI/ML model of the two or more AI/ML models and/or for a functionality thereof depending on a transmission characteristic of a transmission between the user equipment and the network and/or depending on a transmission characteristic of a transmission between the user equipment and another user equipment and/or depending on radio environment properties.

29. An apparatus according to claim 16,
wherein the apparatus is configured to determine the metric for each AI/ML model of the two or more AI/ML models and/or for a functionality thereof depending on a current state of the user equipment and depending on one or more possible future states of the user equipment.

30. An apparatus according to claim 16,
wherein the apparatus is configured to determine the metric for each AI/ML model of the two or more AI/ML models and/or for a functionality thereof depending on two or more possible future actions of the user equipment.

31. An apparatus according to claim 16,
wherein the apparatus is configured to determine the metric for each AI/ML model of the two or more AI/ML models and/or for a functionality thereof depending on a reward function that returns a real value indicating a performance of one of the two or more AI/ML models,
for example, when conducting one of the two or more possible future actions when the user equipment is in a state, the state being one of the current state and the one or more future states.

32. An apparatus according to claim 31,
wherein the reward function returns one of the following values:
for beam management, a value indicating performance, for example, indicating a top-K accuracy of the AI/MHL model or a system throughput achieved with a selected beam,
for CSI compression, a value indicating performance, for example, indicating a throughput or a similarity between a decoder output and a target CSI,
for direct/assisted positioning, a value, for example, indicating a prediction accuracy, for example, as evaluated by a PRU capable of generating ground truth labels.

33. An apparatus according to claim 16,
wherein the apparatus is configured to determine the metric for each AI/ML model of the two or more AI/ML models and/or for a functionality thereof depending on a cost function that takes the effort or the computational cost for activating a particular AI/ML model of the one or more AI/ML models into account, and/or takes the effort or the computational cost for activating a functionality of the particular AI/ML model into account, and/or takes the effort or the computational cost for switching from a current AI/ML model of the one or more AI/ML models to another AI/ML model of the one or more AI/ML models into account.

34. An apparatus according to claim 31,
wherein the apparatus is configured to determine the metric for each AI/ML model of the two or more AI/MBL models and/or for a functionality thereof depending on the reward function and depending on the cost function.

35. An apparatus according to claim 34,
wherein the apparatus is configured to determine the metric for each AI/ML model of the two or more AI/ML models and/or for a functionality thereof by determining a linear combination of the reward function and of the cost function.

36. An apparatus according to claim 31,
wherein the reward function returns a value that penalizes switching from one of the two or more AI/ML models to another one of the two or more AI/ML models.

37. An apparatus according to claim 36,
wherein the reward function returns a value that penalizes a repeatedly conducted switching from one of the two or more AI/MBL models to another one of the two or more AI/ML models.

38. An apparatus according to claim 33,
wherein the apparatus is configured to determine the metric for each AI/MVL model of the two or more AI/MVL models and/or for a functionality thereof depending on the reward function and depending on the cost function,
wherein the cost function returns a value that penalizes switching from one of the two or more AI/ML models to another one of the two or more AI/ML models.

39. An apparatus according to claim 38,
wherein the cost function returns a value that penalizes a repeatedly conducted switching from one of the two or more AI/ML models to another one of the two or more AI/ML models.

40. An apparatus according to claim 1,
wherein each of the one or more AI/NL models are implemented by one or more neural networks.

41. An apparatus according to claim 1,
wherein the task is a positioning task of the user equipment and/or of the network entity.

42. An apparatus according to claim 1,
wherein the task is a management task or a configuration task or of the user equipment and/or of the network entity, for example, a beam management task of the user equipment and/or of the network entity.

43. An apparatus according to claim 1,
wherein the task is a coding task of the user equipment and/or of the network entity or is a compression task of the user equipment and/or of the network entity, for example, a task for compressing channel state information.

44. An apparatus of a wireless communication system,
wherein the apparatus is configured to activate an AI/ML model of one or more AI/ML models and/or a functionality thereof; wherein the one or more AI/ML models are suitable for supporting a task of a user equipment and/or of a network entity of the wireless communication system; wherein the apparatus is the user equipment or is different from the user equipment; wherein it depends on a metric of the AI/ML model and/or of a functionality thereof, if the AI/ML model and/or the functionality thereof is activated,
wherein the metric takes a benefit of employing the AI/ML model and/or the functionality thereof into account, and wherein the metric takes an activation effort for activating the AI/ML model and/or the functionality thereof into account.

45. An apparatus according to claim 44,
wherein the apparatus implements an apparatus according to claim 1.

46. An apparatus according to claim 44,
wherein the apparatus does not implement an apparatus according to claim 1,
wherein the apparatus is configured to receive information on the AI/ML model of one or more AI/ML models that is to be activated from an apparatus according to claim 1.

47. An apparatus according to claim 44, wherein the apparatus is the user equipment.

48. An apparatus according to claim 44,
wherein the apparatus is not the user equipment,
wherein the apparatus is configured to provide an output from the AI/ML model to the user equipment and/or to the network entity to support the user equipment and/or the network entity to perform the task.

49. A user equipment of a wireless communication system,
wherein the user equipment is configured to receive information on an output of an AI/ML model of one or more AI/ML models and/or of a functionality thereof from another apparatus of the wireless communication system, wherein the one or more AI/ML models are suitable for supporting a task of a user equipment and/or of a network entity of the wireless communication system;
wherein it depends on a metric of the AI/ML model and/or of the functionality thereof, if the AI/ML model and/or the functionality thereof has been activated by the other apparatus, wherein the metric takes a benefit of employing the AI/ML model and/or the functionality thereof into account, and wherein the metric takes an activation effort for activating the AI/ML model and/or the functionality thereof into account.

50. A user equipment according to claim 49,
wherein the other apparatus is an apparatus according to claim 44.

51. A wireless communication system, comprising:
an apparatus according to claim 1, and
the user equipment.

52. A wireless communication system according to claim 51,
wherein the wireless communication system further comprises an apparatus according to claim 44.

53. A wireless communication system according to claim 51,
wherein the user equipment is a user equipment according to claim 49.

54. A wireless communication system, comprising,
a first apparatus according to claim 1, and
a second apparatus according to claim 1,
wherein the first apparatus is configured to select and/or to activate one of one or more AI/ML models and/or to switch from one of the one or more AI/ML models to another one of the one or more AI/ML models depending on a selection and/or an activation of one of one or more AI/ML models of the second apparatus and/or depending on a switching from one of the one or more AI/ML models to another one of the one or more AI/ML models.

55. A method for a wireless communication system,
wherein the method comprises determining a metric for an AI/ML model of one or more inactive AI/ML models and/or for a functionality thereof, wherein the one or more inactive AI/ML models are suitable for supporting a task of a user equipment and/or of a network entity of the wireless communication system, wherein the method is executed by the user equipment or by an apparatus of the wireless communication system being different from the user equipment; wherein determining the metric for the AI/ML model and/or for the functionality thereof is conducted, such that the metric takes a benefit of employing the AI/ML model and/or the functionality thereof into account, and such that the metric takes an activation effort for activating the AI/ML model and/or the functionality thereof into account,
wherein the method comprises determining, depending on the metric for the AI/ML model and/or for the functionality thereof, whether or not to activate the AI/ML model and/or the functionality thereof.

56. A method for a wireless communication system,
wherein the method comprises activating an AI/ML model of one or more AI/ML models and/or a functionality thereof, wherein the one or more AI/ML models are suitable for supporting a task of a user equipment and/or of a network entity of the wireless communication system; wherein the method is executed by the user equipment or by an apparatus of the wireless communication system being different from the user equipment; wherein it depends on a metric of the AI/ML model and/or of a functionality thereof, if the AI/ML model and/or the functionality thereof is activated,
wherein the metric takes a benefit of employing the AI/ML model and/or the functionality thereof into account, and wherein the metric takes an activation effort for activating the AI/ML model and/or the functionality thereof into account.

57. A method for a wireless communication system,
wherein the method comprises receiving, by a user equipment, information on an output of an AI/ML model of one or more AI/ML models and/or of a functionality thereof from another apparatus of the wireless communication system, wherein the one or more AI/MHL models are suitable for supporting a task of a user equipment and/or of a network entity of the wireless communication system;
wherein it depends on a metric of the AI/ML model and/or of the functionality thereof, if the AI/ML model and/or the functionality thereof has been activated by the other apparatus, wherein the metric takes a benefit of employing the AI/ML model and/or the functionality thereof into account, and wherein the metric takes an activation effort for activating the AI/ML model and/or the functionality thereof into account.

58. A non-transitory digital storage medium having a computer program stored thereon to perform the method of claim 55 or 56 or 57 when said computer program is run by a computer.
